(19) United States
(12) Patent Application Publication
(10) Pub. No.: US 2025/0106728 A1
(43) Pub. Date: Mar. 27, 2025

(54) PATH MANAGEMENT OF A SIDELINK RELAY BETWEEN USER EQUIPMENT

(71) Applicant: QUALCOMM INCORPORATED, San Diego, CA (US)

(72) Inventors: Peng Cheng, Beijing (CN); Karthika Paladugu, Hyderabad (IN); Hong Cheng, Basking Ridge, NJ (US); Soo Bum Lee, San Diego, CA (US)

(21) Appl. No.: 18/729,854

(22) PCT Filed: Mar. 22, 2022
(86) PCT No.: PCT/CN2022/082207

§ 371 Date: Jul. 17, 2024

(51) Int. Cl. H04W 40/22; H04W 8/00; H04W 88/04

(52) U.S. Cl. CPC H04W 40/22; H04W 8/005; H04W 88/04

(57) ABSTRACT

Methods, systems, and devices for wireless communication are described. One or more second user equipments (UEs) may determine to communicate with a third UE and perform route discovery techniques based on a sidelink relay operation. The third UE may determine to utilize a first UE to facilitate communicating with the third UE. The second UEs may transmit control signaling to the first UE indicating a request for one or more temporary identifications assigned to the second UEs, the third UE, or both. The first UE may generate the one or more temporary identifications and transmit the one or more temporary identifications to the second UEs and the third UE. The first UE may relay further communications associated with an end-to-end (E2E) link that include the one or more temporary identifications in a sidelink relay adaptation protocol (SRAP) header.

### CROSS REFERENCE

The present application is a 371 national stage filing of International PCT Application No. PCT/CN2022/082207 by Cheng et al. entitled “PATH MANAGEMENT OF A SIDELINK RELAY BETWEEN USER EQUIPMENT,” filed Mar. 22, 2022, which is assigned to the assignee hereof, and which is expressly incorporated by reference in its entirety herein.

### FIELD OF TECHNOLOGY

The following relates to wireless communication, including path management of a sidelink relay between user equipment.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more network entities, each supporting wireless communication for communication devices, which may be known as user equipment (UE).

### SUMMARY

The described techniques relate to improved methods, systems, devices, and apparatuses that support path management of a sidelink relay between user equipment (UE). For example, the described techniques generally provide procedures for path management of a sidelink relay between UEs (e.g., UE-to-UE (U2U)). The techniques enable a first UE to relay communications between one or more second UEs and a third UE based on a relay operation. For example, the second UEs may determine to communicate with a third UE and perform route discovery techniques to determine a path of communication between the second UEs and the third UE based on a sidelink relay operation. The third UE may determine to utilize a first UE to facilitate communicating with the third UE. The second UEs may transmit control signaling to the first UE indicating a request for one or more temporary identifications assigned to the second UEs, the third UE, or both. The first UE may generate the one or more temporary identifications and transmit the one or more temporary identifications to the second UEs and the third UE. In some cases, the first UE may relay further communications (e.g., associated with establishing an end-to-end (E2E) direct link) that include the one or more temporary identifications in a sidelink relay adaptation protocol (SRAP) header.

In some instances, the SRAP header may include a temporary identification assigned to the second UEs, a temporary identification assigned to the third UE, an identification assigned to resources associated with the SRAP header, or any combination thereof. In some cases, the second UEs may determine and/or change a quality of service (QOS) associated with the E2E direct link. The second UEs may transmit one or more messages including the SRAP header and information about the E2E QoS. The first UE may determine a QoS split and whether to update the one or more temporary identifications. The first UE may communicate with the second UEs and the third UE the SRAP header, link information, the updated one or more temporary identifications, or any combination thereof, based on the determination. In some cases, the second UEs may determine to establish multiple E2E links, where each E2E link includes a different path of communication between the second UEs and the third UE (e.g., one or more fourth UEs). In some examples, the first UE may determine a radio link failure (RLF), a sidelink deficiency (e.g., a sidelink measurement being below a threshold), or both, and transmit a message indicating the failure, the deficiency, or both, to the second UEs or the first UE (e.g., depending on which link is associated with the determination). Based on the message, the second UEs or the first UE may release or reconfigure the associated link, and, in some cases, the second UEs may activate a second E2E link of the multiple E2E links in order to continue communications between the second UEs and the third UE.

A method for wireless communication at a first user equipment (UE) is described. The method may include relaying communications between one or more second UEs and a third UE based on a sidelink relay operation where the relaying includes communicating with the one or more second UEs over a first link and communicating with the third UE over a second link, receiving, from the one or more second UEs, control signaling indicating a request for one or more temporary identifications assigned to the one or more second UEs, the third UE, or both, for the sidelink relay operation, and transmitting signaling including a SRAP header to the one or more second UEs and the third UE, where the SRAP header includes the one or more temporary identifications.

An apparatus for wireless communication at a first UE is described. The apparatus may include a processor, memory coupled with the processor, and instructions stored in the memory. The instructions may be executable by the processor to cause the apparatus to relay communications between one or more second UEs and a third UE based on a sidelink relay operation where the relaying includes communicating with the one or more second UEs over a first link and communicating with the third UE over a second link, receive, from the one or more second UEs, control signaling indicating a request for one or more temporary identifications assigned to the one or more second UEs, the third UE, or both, for the sidelink relay operation, and transmit signaling including a SRAP header to the one or more second UEs and the third UE, where the SRAP header includes the one or more temporary identifications.

Another apparatus for wireless communication at a first UE is described. The apparatus may include means for relaying communications between one or more second UEs and a third UE based on a sidelink relay operation where the relaying includes communicating with the one or more second UEs over a first link and communicating with the third UE over a second link, means for receiving, from the one or more second UEs, control signaling indicating a request for one or more temporary identifications assigned to the one or more second UEs, the third UE, or both, for the sidelink relay operation, and means for transmitting signaling including a SRAP header to the one or more second UEs and the third UE, where the SRAP header includes the one or more temporary identifications.

A non-transitory computer-readable medium storing code for wireless communication at a first UE is described. The code may include instructions executable by a processor to relay communications between one or more second UEs and a third UE based on a sidelink relay operation where the relaying includes communicating with the one or more second UEs over a first link and communicating with the third UE over a second link, receive, from the one or more second UEs, control signaling indicating a request for one or more temporary identifications assigned to the one or more second UEs, the third UE, or both, for the sidelink relay operation, and transmit signaling including a SRAP header to the one or more second UEs and the third UE, where the SRAP header includes the one or more temporary identifications.

Some examples of the method, apparatuses, and non-transitory computer-readable medium described herein may further include operations, features, means, or instructions for transmitting the one or more temporary identifications assigned to the one or more second UEs, the third UE, or both, to the one or more second UEs, the third UE, or both, based on the control signaling.

In some examples of the method, apparatuses, and non-transitory computer-readable medium described herein, transmitting the signaling may include operations, features, means, or instructions for relaying one or more messages associated with establishing an E2E link of a set of E2E links between the one or more second UEs and the third UE based on the sidelink relay operation, where the one or more messages include the SRAP header.

In some examples of the method, apparatuses, and non-transitory computer-readable medium described herein, a link request, a security message, a dynamic channel assignment message, or any combination thereof.

In some examples of the method, apparatuses, and non-transitory computer-readable medium described herein, transmitting the signaling may include operations, features, means, or instructions for relaying one or more messages associated with an access stratum procedure, where the one or more messages include the SRAP header.

In some examples of the method, apparatuses, and non-transitory computer-readable medium described herein, relaying the one or more messages may include operations, features, means, or instructions for receiving a QoS message associated with the first link and the second link based on the access stratum procedure, where the one or more messages includes the QoS message, relaying a sidelink radio link control channel message, where the sidelink radio link control channel message may be determined based on the QoS message, relaying one or more updated temporary identifications assigned to the one or more second UEs, the third UE, or both, based on the QoS message, and determining a QoS split based on the QoS message.

In some examples of the method, apparatuses, and non-transitory computer-readable medium described herein, a PC5 radio resource control (RRC) message, one or more RRC reconfiguration sidelink messages, or any combination thereof.

Some examples of the method, apparatuses, and non-transitory computer-readable medium described herein may further include operations, features, means, or instructions for determining a first temporary identification assigned to the one or more second UEs, a second temporary identification assigned to the third UE, a temporary identification index pair associated with the one or more second UEs and the third UE, a radio bearer identification associated with the sidelink relay operation, or any combination thereof, based on the control signaling, where the SRAP header includes the first temporary identification, the second temporary identification, the temporary identification index pair, the radio bearer identification, or any combination thereof.

Some examples of the method, apparatuses, and non-transitory computer-readable medium described herein may further include operations, features, means, or instructions for determining a RLF on the first link or the second link, where the first link and the second link may be associated with a first E2E link of a set of E2E links, transmitting a failure message to the one or more second UEs or the third UE based on the determining the RLF, and communicating with the third UE based on a path management procedure, where the path management procedure includes multiplexing reconfiguration or releasing the first link.

In some examples of the method, apparatuses, and non-transitory computer-readable medium described herein, transmitting the failure message may include operations, features, means, or instructions for transmitting the failure message to the one or more second UEs based on the RLF being associated with the second link and transmitting the failure message to the third UE based on the RLF being associated with the first link.

Some examples of the method, apparatuses, and non-transitory computer-readable medium described herein may further include operations, features, means, or instructions for determining a sidelink measurement associated with the first link may be below a threshold, where the threshold may be configured, preconfigured, or both and communicating with the third UE based on a path management procedure, where the path management procedure includes multiplexing reconfiguration or releasing the first link.

In some examples of the method, apparatuses, and non-transitory computer-readable medium described herein, the control signaling includes a PC5 RRC message and the first link and the second link include an E2E PC5 sidelink link.

A method for wireless communication at a second UE is described. The method may include communicating with a first UE over a first link based on a sidelink relay operation between the second UE and a third UE, transmitting, to the first UE, control signaling indicating a request for one or more temporary identifications assigned to the second UE, the third UE, or both, for the sidelink relay operation, and receiving signaling including a SRAP header, where the SRAP header includes the one or more temporary identifications.

An apparatus for wireless communication at a second UE is described. The apparatus may include a processor, memory coupled with the processor, and instructions stored in the memory. The instructions may be executable by the processor to cause the apparatus to communicate with a first UE over a first link based on a sidelink relay operation between the second UE and a third UE, transmit, to the first UE, control signaling indicating a request for one or more temporary identifications assigned to the second UE, the third UE, or both, for the sidelink relay operation, and receive signaling including a SRAP header, where the SRAP header includes the one or more temporary identifications.

Another apparatus for wireless communication at a second UE is described. The apparatus may include means for communicating with a first UE over a first link based on a sidelink relay operation between the second UE and a third UE, means for transmitting, to the first UE, control signaling indicating a request for one or more temporary identifications assigned to the second UE, the third UE, or both, for the sidelink relay operation, and means for receiving signaling including a SRAP header, where the SRAP header includes the one or more temporary identifications.

A non-transitory computer-readable medium storing code for wireless communication at a second UE is described. The code may include instructions executable by a processor to communicate with a first UE over a first link based on a sidelink relay operation between the second UE and a third UE, transmit, to the first UE, control signaling indicating a request for one or more temporary identifications assigned to the second UE, the third UE, or both, for the sidelink relay operation, and receive signaling including a SRAP header, where the SRAP header includes the one or more temporary identifications.

Some examples of the method, apparatuses, and non-transitory computer-readable medium described herein may further include operations, features, means, or instructions for receiving the one or more temporary identifications assigned to the second UE, the third UE, or both, from the first UE based on the control signaling.

In some examples of the method, apparatuses, and non-transitory computer-readable medium described herein, receiving the signaling may include operations, features, means, or instructions for communicating one or more messages associated with establishing a set of E2E links between the second UE and the third UE based on the sidelink relay operation, where the one or more messages include one or more SRAP headers.

Some examples of the method, apparatuses, and non-transitory computer-readable medium described herein may further include operations, features, means, or instructions for determining that an E2E link of the set of E2E links associated with the first UE may be active, where other E2E links of the set of E2E links may be inactive.

In some examples of the method, apparatuses, and non-transitory computer-readable medium described herein, the one or more SRAP headers include a different SRAP header associated with each E2E link of the set of E2E links and the one or more messages include a link request, a security message, a dynamic channel assignment message, or any combination thereof.

In some examples of the method, apparatuses, and non-transitory computer-readable medium described herein, receiving the signaling may include operations, features, means, or instructions for communicating one or more messages associated with an access stratum procedure, where the one or more messages include the SRAP header.

In some examples of the method, apparatuses, and non-transitory computer-readable medium described herein, communicating the one or more messages may include operations, features, means, or instructions for transmitting a QoS message associated with the first link and a second link, where the second link may be associated with the sidelink relay operation, and where the one or more messages includes the Qos message, receiving a sidelink radio link control channel message, where the sidelink radio link control channel message may be determined based on the QoS message, and receiving one or more updated temporary identifications assigned to the second UE, the third UE, or both, based on the QoS message.

In some examples of the method, apparatuses, and non-transitory computer-readable medium described herein, a PC5 RRC message, one or more RRC reconfiguration sidelink messages, or both.

Some examples of the method, apparatuses, and non-transitory computer-readable medium described herein may further include operations, features, means, or instructions for determining a first temporary identification assigned to the second UE, a second temporary identification assigned to the third UE, a temporary identification index pair associated with the second UE and the third UE, a radio bearer identification associated with the sidelink relay operation, or any combination thereof, based on the SRAP header.

Some examples of the method, apparatuses, and non-transitory computer-readable medium described herein may further include operations, features, means, or instructions for determining whether to release the first link based on a performance indication associated with the first link, a second link, or both, where the first link and the second link may be associated with a first E2E link of a set of E2E links.

Some examples of the method, apparatuses, and non-transitory computer-readable medium described herein may further include operations, features, means, or instructions for receiving a failure message from the first UE based on a RLF associated with the second link, where the performance indication includes the failure message and communicating with the first UE based on a path management procedure, where the path management procedure includes multiplexing reconfiguration or releasing the first link.

Some examples of the method, apparatuses, and non-transitory computer-readable medium described herein may further include operations, features, means, or instructions for determining a sidelink measurement associated with the first link may be below a threshold, where the threshold may be configured, preconfigured, or both, and the performance indication may be indicative of the first link being below the threshold and communicating with the first UE based on a path management procedure, where the path management procedure includes multiplexing reconfiguration or releasing the first link.

Some examples of the method, apparatuses, and non-transitory computer-readable medium described herein may further include operations, features, means, or instructions for communicating with a fourth UE associated with a second E2E link of the set of E2E links based on a reselection procedure, where a start of the reselection procedure may be based on the determining whether to release the first link.

In some examples of the method, apparatuses, and non-transitory computer-readable medium described herein, the reselection procedure may include operations, features, means, or instructions for deactivating the first E2E link, activating the second E2E link, where the second E2E link may be determined based on sidelink measurements associated with a third link of the second E2E link, a fourth link of the second E2E link, or both, and communicating one or more messages associated with establishing the second E2E link based on the activating the second E2E link.

In some examples of the method, apparatuses, and non-transitory computer-readable medium described herein, a minimum value of a sidelink reference signal received power (SL-RSRP), a sidelink discovery reference signal received power (SD-RSRP), or both, associated with the third link and the fourth link, a mean value of a SL-RSRP, a SD-RSRP, or both, associated with the third link and the fourth link, and a value of a SL-RSRP, a SD-RSRP, or both, associated with the third link.

In some examples of the method, apparatuses, and non-transitory computer-readable medium described herein, the control signaling includes a PC5 RRC message and the first link and a second link associated with the sidelink relay operation include an E2E PC5 sidelink link.

### BRIEF DESCRIPTION OF THE DRAWINGS

FIGS. 1 and 2 illustrate examples of wireless communications systems that support path management of a sidelink relay between user equipment in accordance with one or more aspects of the present disclosure.

FIGS. 3A, 3B, and 3C illustrate examples of configurations that support path management of a sidelink relay between user equipment in accordance with one or more aspects of the present disclosure.

FIGS. 4 through 8 illustrate examples of process flows that support path management of a sidelink relay between user equipment in accordance with one or more aspects of the present disclosure.

FIGS. 9 and 10 show block diagrams of devices that support path management of a sidelink relay between user equipment in accordance with one or more aspects of the present disclosure.

FIG. 11 shows a block diagram of a communications manager that supports path management of a sidelink relay between user equipment in accordance with one or more aspects of the present disclosure.

FIG. 12 shows a diagram of a system including a device that supports path management of a sidelink relay between user equipment in accordance with one or more aspects of the present disclosure.

FIGS. 13 through 16 show flowcharts illustrating methods that support path management of a sidelink relay between user equipment in accordance with one or more aspects of the present disclosure.

### DETAILED DESCRIPTION

In some wireless communications systems, a first user equipment (UE) may relay communications between a second UE and a third UE. For example, the communication may be over a sidelink link between the second UE and the third UE. In some cases, the second UE may determine to establish a link with a first UE in order to communicate with the third UE. For example, the third UE may be inaccessible to the second UE for a direct link (e.g., due to distance, interference, etc.), the UEs may be a part of a vehicle-to-everything (V2X) operation that promotes using a relay UE, or both, among other examples. In some cases, the first UE may be a relay UE that may facilitate (relay) communications between the second UE and the third UE. In some examples, a first link between the second UE and the first UE and a second link between the first UE and the third UE may be an end-to-end (E2E) link, as part of a UE-to-UE (U2U) relaying operation. However, some techniques do not support a procedure for E2E link establishment, path management, protocols, and multi-path relays associated with a U2U relaying operation. Because of the lack of support for E2E links associated with U2U relaying operation, the second UE may not be able to communicate with the third UE. This may lead to inefficient V2X operations, a lack of flexibility for sidelink communications, inefficient use of resources, and other drawbacks.

The techniques described herein provide procedures for path management of a sidelink relay between UEs (e.g., U2U). For example, a second UE may determine to communicate with a third UE and perform route discovery techniques to determine a path of communication between the second UE and the third UE based on a sidelink relay operation. The third UE may determine to utilize a first UE to facilitate communicating with the third UE. The second UE may transmit control signaling to the first UE indicating a request for one or more temporary identifications assigned to the second UE, the third UE, or both. The first UE may generate the one or more temporary identifications and transmit the one or more temporary identifications to the second UE and the third UE. In some cases, the first UE may relay further communications (e.g., associated with establishing an E2E direct link) that include the one or more temporary identifications in a sidelink relay adaptation protocol (SRAP) header.

In some instances, the SRAP header may include a temporary identification assigned to the second UE, a temporary identification assigned to the third UE, an identification assigned to resources associated with the SRAP header, or any combination thereof. In some cases, the second UE may determine and/or change a quality of service (QOS) associated with the E2E direct link. The second UE may transmit one or more messages including the SRAP header and information about the E2E QoS. The first UE may determine a QoS split and whether to update the one or more temporary identifications. The first UE may communicate with the second UE and the third UE the SRAP header, link information, the updated one or more temporary identifications, or any combination thereof, based on the determination. In some cases, the second UE may determine to establish multiple E2E links, where each E2E link includes a different path of communication between the second UE and the third UE (e.g., one or more fourth UEs). In some examples, the first UE may determine a radio link failure (RLF), a sidelink deficiency (e.g., a sidelink measurement being below a threshold), or both, and transmit a message indicating the failure, the deficiency, or both, to the second UE or the first UE (e.g., depending on which link is associated with the determination). Based on the message, the second UE or the first UE may release or reconfigure the associated link, and, in some cases, the second UE may activate a second E2E link of the multiple E2E links in order to continue communications between the second UE and the third UE.

Aspects of the disclosure are initially described in the context of wireless communications systems. Aspects of the disclosure are then described with reference to different configurations and process flows. Aspects of the disclosure are further illustrated by and described with reference to apparatus diagrams, system diagrams, and flowcharts that relate to path management of a sidelink relay between user equipment.

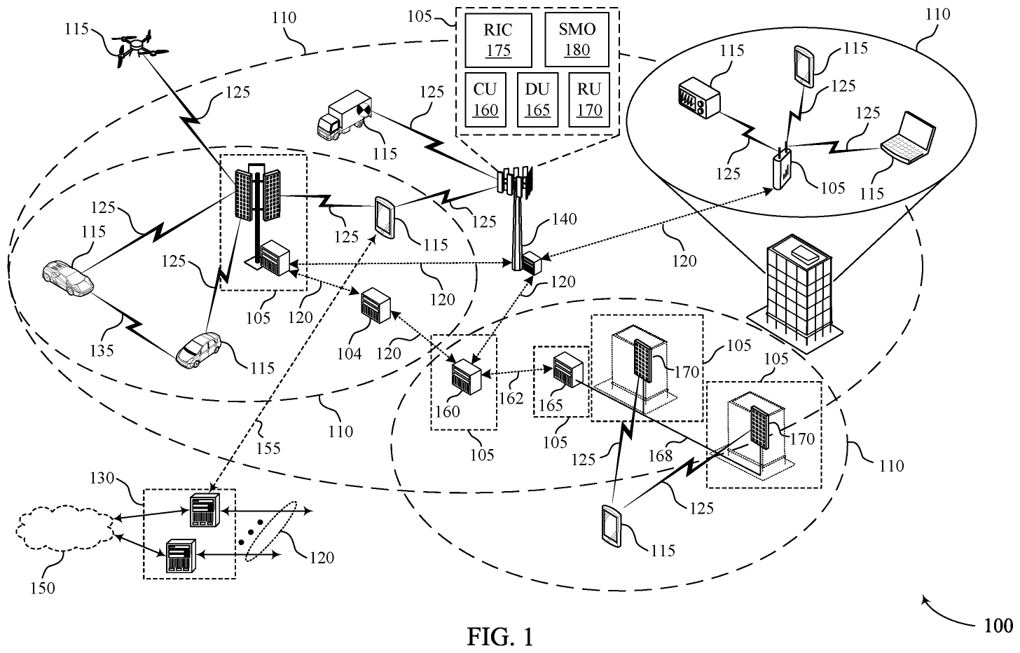

FIG. 1 illustrates an example of a wireless communications system 100 that supports path management of a sidelink relay between user equipment in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support path management of a sidelink relay between user equipment as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using V2X communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples of the wireless communications system 100, one or more wireless devices may support sidelink relay enhancements. The sidelink relay enhancements may include solutions for enhancing NR sidelink relay for V2X, public safety, and commercial use cases. For example, a first solution may specify mechanisms to support single-hop layer-2 (L2) and layer-3 (L3) U2U relay (e.g., a source UE 115 to a relay UE 115 to a destination UE 115) for unicast and/or groupcast (e.g., RAN2, RAN3, RAN4, etc.). A first mechanism may include a common part for L2 and L3 relay may be prioritized until RAN #98 (e.g., relay discovery and reselection for RAN2 and RAN4 or relay and remote UE authorization for RAN3). A second mechanism may include an L2 relay specific part. The relay specific part may include a U2U relay adaptation layer design, control plane procedures, QoS handling (if needed), subject to SA2 progress, or any combination thereof for RAN2. In some cases, the first solution may consider forward compatibility for supporting more than one hop. In some cases of the first solution, a remote UE 115 may be connected to only a single relay UE 115 at a given time, where the relay reselection criterion is the same in uncast and groupcast.

A second solution may specify mechanisms to enhance service continuity for single-hop L2 UE-to-Network (U2N) relay for RAN2 and RAN3. For example, the mechanisms may include inter-network entity indirect-to-direct path switching (e.g., from a UE 115 to relay UE 115 to network entity 105 link to a UE 115 to network entity 105 link), inter-network entity direct-to-indirect path switching (e.g., from a UE 115 to network entity 105 link to a UE 115 to relay UE 115 to network entity 105 link), inter-network entity indirect-to-indirect path switching (e.g., from a UE 115 to a first relay UE 115 to network entity 105 link to the UE 115 to a second relay UE 115 to network entity 105 link), inter-network entity indirect-to-indirect path switching (e.g., from a UE 115 to a first relay UE 115 to a first network entity 105 link to the UE 115 to a second relay UE 115 to a second network entity 105 link). In some cases, the indirect-to-indirect path switching may be supported by reusing solutions for the other scenarios without specific optimizations.

A third solution may include multi-path support in L2 and/or L3 U2N relay for enhanced reliability and throughput in RAN2. For example, a UE 115 may be connected to a same network entity 105 by using one direct path and one indirect path. A fourth solution may include support for sidelink discontinuous receive (DRX) for sidelink relay operation.

In some cases, a first UE 115 (e.g., a relay UE 115) may relay traffic between a second UE 115 and a third UE 115 as part of a U2U relay operation. In some cases, the second UE 115 may be the originator of the relaying traffic (e.g., a source UE 115) and the third UE 115 may be the destination of the relaying traffic (e.g., a destination UE 115). To facilitate the relay communication, the second UE 115 may establish a first link (e.g., a first hop) with the first UE 115 and the first UE 115 may establish a second link (e.g., a second hop) with the third UE 115 in order for the second UE 115 to communicate with the third UE 115. In some examples, the first link and the second link may be an example of single-hop relaying, where a single relay UE 115 relays communications between a source UE 115 and a destination UE 115. In some other examples, the first link and the second link may represent multiple links as part of a multi-hop relay, where more than one relay UEs 115 are connected to each other to support relaying communications between the second UE 115 and the third UE 115 (e.g., a source UE 115 is linked to a first relay UE 115 that is linked to one or more second relay UEs 115).

In some examples, the relay operation may include different coverage scenarios. For example, a Uu coverage of the UEs 115 participating in the U2U relaying may be different. The different coverage scenarios may include an out-of-coverage scenario, an in-coverage scenario, and a partial-coverage scenario. An example of the out-of-coverage scenario may include, all of the UEs 115 participating in the U2U relaying operation being out-of-coverage of one or more network entities 105. An example of the in-coverage scenario may include, all of the UEs 115 participating in the U2U relaying operation being in-coverage of one or more network entities 105 (e.g., the UEs 115 may be in-coverage of different cells). An example of the partial-coverage scenario may include, at least one of the UEs 115 participating in the U2U relaying operation being in-coverage of one or more network entities 105 (e.g., one or more of the UEs 115 may be in-coverage of different cells).

In some examples, the U2U relaying operation may enable a coverage extension of sidelink transmissions between sidelink UEs. For example, the third UE may be inaccessible to the second UE for a direct link (e.g., due to distance, interference, etc.), the UEs may be a part of a V2X operation that promotes using a relay UE, or both, among other examples. In some examples, a first link between the second UE and the first UE and a second link between the first UE and the third UE may be an E2E link, as part of the U2U relaying operation. However, some techniques do not support a procedure for E2E link establishment, path management, protocols, and multi-path relays associated with a U2U relaying operation. Because of the lack of support for E2E links associated with U2U relaying operation, the second UE may not be able to communicate with the third UE. This may lead to inefficient V2X operations, a lack of flexibility for sidelink communications, inefficient use of resources, and other drawbacks.

The techniques described herein provide procedures for path management of a sidelink relay between UEs (e.g., filling missing aspects of L2 U2U design). For example, the techniques may include an SRAP header format design for L2 U2U relay, overall procedures of how to establish an E2E PC5 link of L2 U2U relay (e.g., signaling specification impacts of PC5-S and PC5-RRC), how local identifiers of SRAP are assigned in sidelink (e.g., signaling radio bearer (SRB) 0, SRB1, SRB2, SRB3, and data radio bearer (DRB)), how to manage QoS (e.g., which UE 115 may split E2E QoS and how the relay UE 115 may determine to split the E2E QoS), when a source UE 115 may trigger PC5 link release and relay reselection (e.g., related signaling impacts and procedures), enhancements via multi-path relay in which a source UE 115 may establish multiple E2E PC5-S links with a destination UE 115 in which only one link is active in the access stratum (AS) (e.g., to reduce latency incurred by relay resection), among other examples.

In some examples, a second UE may determine to communicate with a third UE and perform route discovery techniques to determine a path of communication between the second UE and the third UE based on a sidelink relay operation. The third UE may determine to utilize a first UE to facilitate communicating with the third UE. The second UE may transmit control signaling to the first UE indicating a request for one or more temporary identifications assigned to the second UE, the third UE, or both. The first UE may generate the one or more temporary identifications and transmit the one or more temporary identifications to the second UE and the third UE. In some cases, the first UE may relay further communications (e.g., associated with establishing an E2E direct link) that include the one or more temporary identifications in a SRAP header.

In some instances, the SRAP header may include a temporary identification assigned to the second UE, a temporary identification assigned to the third UE, an identification assigned to resources associated with the SRAP header, or any combination thereof. In some cases, the second UE may determine and/or change a QoS associated with the E2E direct link. The second UE may transmit one or more messages including the SRAP header and information about the E2E QoS. The first UE may determine a QoS split and whether to update the one or more temporary identifications. The first UE may communicate with the second UE and the third UE the SRAP header, link information, the updated one or more temporary identifications, or any combination thereof, based on the determination. In some cases, the second UE may determine to establish multiple E2E links, where each E2E link includes a different path of communication between the second UE and the third UE (e.g., one or more fourth UEs). In some examples, the first UE may determine a RLF, a sidelink deficiency (e.g., a sidelink measurement being below a threshold), or both, and transmit a message indicating the failure, the deficiency, or both, to the second UE or the first UE (e.g., depending on which link is associated with the determination). Based on the message, the second UE or the first UE may release or reconfigure the associated link, and, in some cases, the second UE may activate a second E2E link of the multiple E2E links in order to continue communications between the second UE and the third UE.

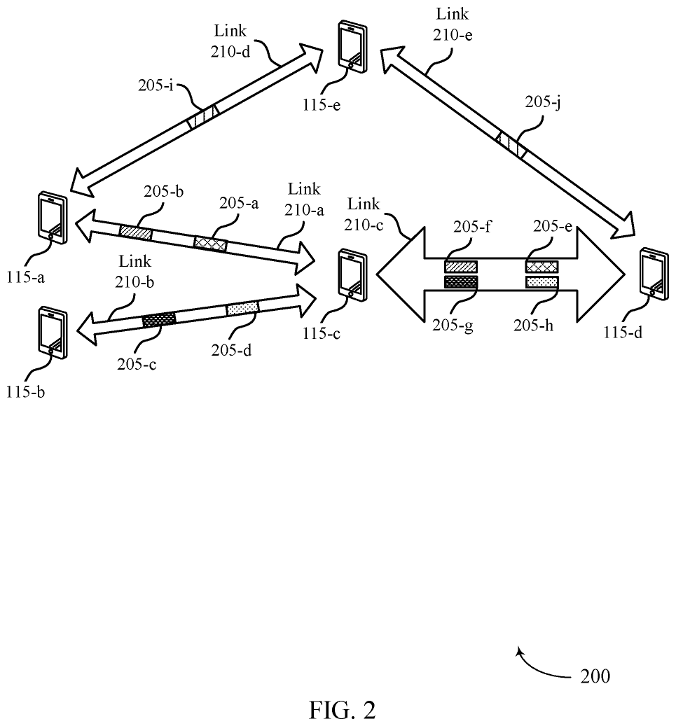

FIG. 2 illustrates an example of a wireless communications system 200 that supports path management of a sidelink relay between user equipment in accordance with one or more aspects of the present disclosure. In some examples, the wireless communications system 200 may implement aspects of the wireless communications system 100. For example, the wireless communications system 200 may include a UE 115-a, a UE 115-b, a UE 115-c, a UE 115-d, and a UE 115-e, which may be examples of a UE 115, as described herein with reference to FIG. 1. In some cases, the UEs 115-a and 115-b may represent examples of a source UE 115, the UEs 115-c and 115-e a relay UE 115, and the UE 115-d a destination UE 115, where the source UE 115 and the destination UE 115 are in sidelink communication with the relay UE 115. The source UE 115 may be defined as the originator of relaying traffic and the destination UE 115 may be defined as the destination of relaying traffic. The UE 115-c and the UE 115-e may also represent multiple relay UEs 115 as part of a multi-hop relay operation, as described herein with reference to FIG. 1. The UE 115-a, the UE 115-b, the UE 115-c, the UE 115-d, and/or the UE 115-e, or any combination thereof, may be in wireless communication.

In some cases, multiple UEs 115 may be in wireless communication as part of a relay operation (e.g., U2U relaying). The relay operation may enable an extension of a sidelink coverage, such that the UE 115-a may communicate with the UE 115-d through the UE 115-c. For example, the UE 115-d may be inaccessible to the UE 115-a for a direct link (e.g., due to distance, interference, etc.) and may use the UE 115-c to facilitate (relay) sidelink communications to the UE 115-d through an indirect link (e.g., multiple single hop links that form a direct E2E link). However, some techniques may not support a procedure for E2E link establishment, path management, protocols, and/or multi-path relays associated with a U2U relay operation. Because of the lack of support for E2E links associated with U2U relay operations, the UE 115-a may not be able to communicate with the UE 115-d. This may lead to inefficient V2X operations, a lack of flexibility for sidelink communications, inefficient use of resources, and other drawbacks.

In order to facilitate E2E link and U2U relay operations, aspects of the present disclosure enable path management of a sidelink relay between the UE 115-a and the UE 115-d. For example, the UE 115-a may establish a sidelink link 210-a (e.g., a first hop) with the UE 115-c. The link 210-a may include a radio bearer (RB) 205-b and an RB 205-a (e.g., multiple E2E RB channels) that the UE 115-a may utilize to transfer sidelink communications to the UE 115-c. The UE 115-c may then relay the sidelink communications over a link 210-c (e.g., a second hop) to the UE 115-d. The link 210-c may include an RB 205-f and an RB 205-e that correspond to the RB 205-b and the RB 205-a respectively.

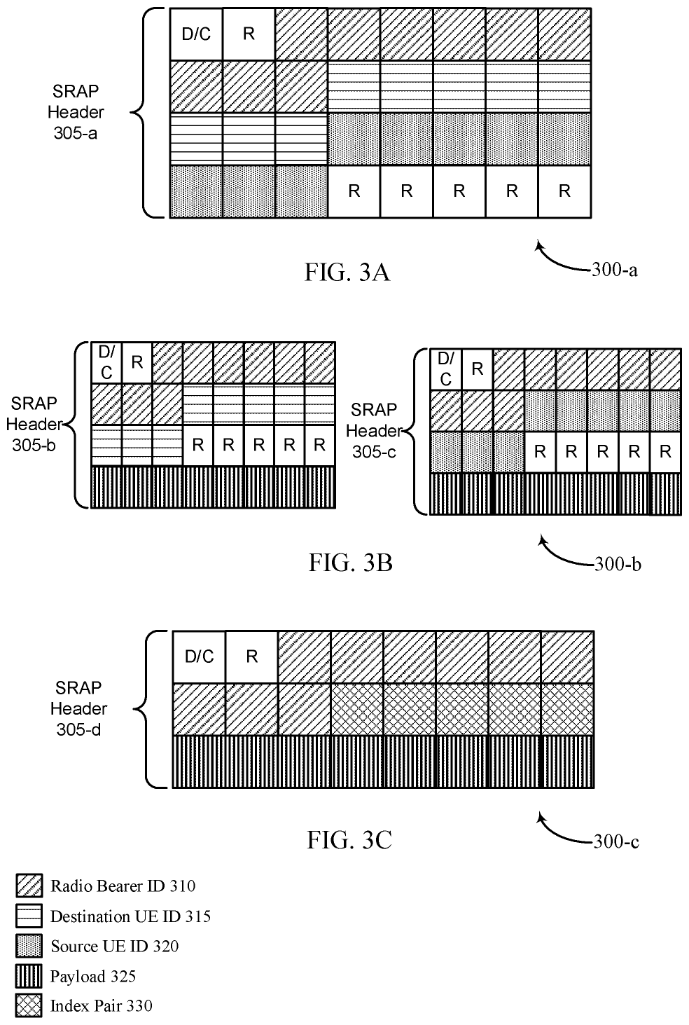

In some cases, the sidelink communications may include user and/or control data. For example, a control plane and/or a user plane may include multiple layers as part of a protocol stack, such as an adaptation layer. Within the adaptation layer, the UE 115-a may transmit an SRAP that provides functionalities of bearer mapping and routing (e.g., similar to L2 U2N relay), as described herein with reference to FIG. 3. In some cases, a first bearer mapping may be up to the UE 115-a implementation. For example, the UE 115-a may multiplex the RB 205-a and the RB 205-b together as a first PC5 RLC bearer (e.g., such that there is one bearer mapping from E2E bearer identifier to an egress PC5 RLC channel). The UE 115-a may determine an E2E link identification of the UE 115-d (e.g., the destination UE 115) and route traffic to an associated (corresponding) sidelink DRB PDCP entity. In some cases, a second bearer mapping may be up to the UE 115-c implementation. For example, the UE 115-c may multiplex the RB 205-f and the RB 205-e together as a second PC5 RLC bearer (e.g., such that there is one bearer mapping from an ingress PC5 RLC channel to an egress PC5 RLC channel). The UE 115-d may determine an E2E link identification and route traffic to an associated (corresponding) sidelink DRB PDCP entity.

While described primarily with reference to the UE 115-a, the described examples may also relate to multiple source UEs 115. For example, both the UE 115-a and the UE 115-b may establish sidelink links 210 with the UE 115-c. The UE 115-b may establish a link 210-b with the UE 115-c and transmit relay communications to the UE 115-c over the link 210-b. In some examples, the link 210-b may include an RB 205-c multiplexed with an RB 205-d, which the UE 115-b may use to transfer different relay communications. The UE 115-c may determine a third RB mapping where the RB 205-f, the RB 205-e, an RB 205-g, and an RB 205-h (where the RB 205-g and the RB 205-h are associated with the RB 205-c and the RB 205-d respectively) may be multiplexed in a third PC5 RLC bearer (e.g., a same PC5 RLC bearer).

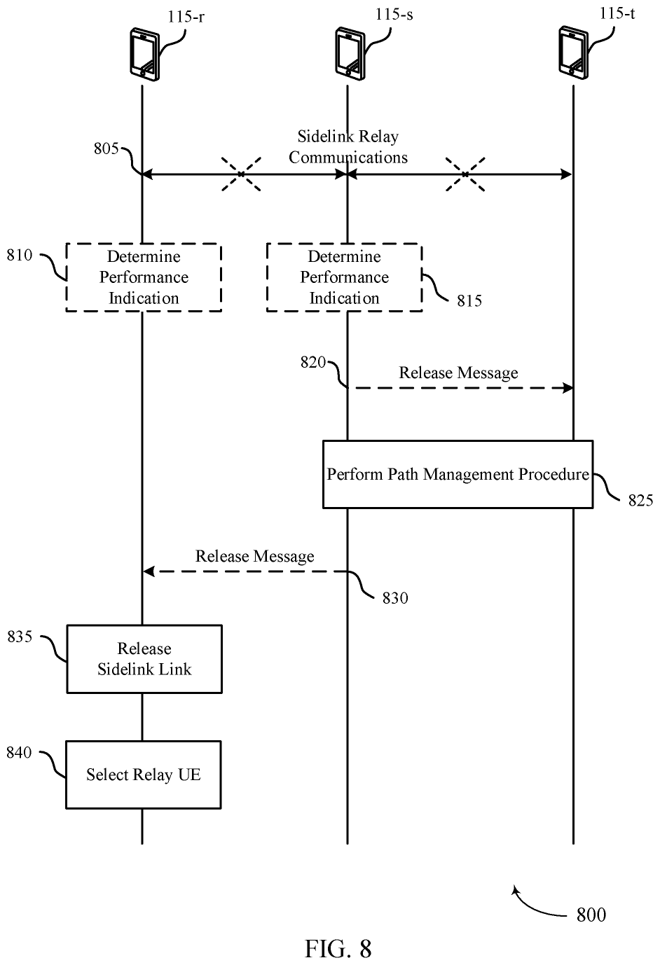

In some cases, the UE 115-a may determine to establish multiple E2E links as part of a multi-path relay operation. For example, the UE 115-a may establish a link 210-d with the UE 115-e and the UE 115-e may establish a link 210-e with the UE 115-d, such that the links 210-d and 210-e comprise a second E2E link between the UE 115-a and the UE 115-d. In some examples, the link 210-d may include an RB 205-I and the link 210-e may include an RB 205-j. In some cases, the second E2E link may be a dormant (inactive) link and a first E2E link that includes the link 210-a and the link 210-c may be an active link. In some cases, the multi-path relay operation may be an enhancement of the relay operation that may reduce latency incurred by relay reselection. For example, the UE 115-a may detect a problem with the first E2E link (e.g., a RLF or a sidelink measurement being below a threshold) based on a performance indication, as described herein with reference to FIG. 8. Rather than performing another search and establishment procedure with another relay UE 115, the UE 115-a may determine to activate the second E2E link with the UE 115-e and continue sidelink communication with the UE 115-d, thus reducing the latency incurred by relay reselection. In some cases, the UE 115-a may establish a set of E2E links (e.g., multiple E2E PC5-S links) in which only one E2E link of the set is active (e.g., active in the AS).

The examples described herein are meant to be illustrative of path management of sidelink relay, and are not to be construed as limiting to only these specific implementations. For example, the UE 115-c and the UE 115-e may be an example of multiple relay UEs 115 as part of a multi-hop relay operation, where the E2E link includes the multiple relay UEs 115.

FIGS. 3A, 3B, and 3C illustrates an example of a configuration 300-a, a configuration 300-b, and a configuration 300-c respectively, that support path management of a sidelink relay between user equipment in accordance with one or more aspects of the present disclosure. In some examples, the configuration 300-a, the configuration 300-b, and the configuration 300-c may implement or be implemented by aspects of the wireless communications system 100 and the wireless communications system 200, as described in in FIGS. 1 and 2. For example, one or more of the configuration 300-a, the configuration 300-b, and the configuration 300-c may be implemented by one or more UEs 115 to support procedures for path management of a sidelink relay.

In some cases, a relay UE 115 may relay communications between one or more source UEs 115 and a destination UE 115 (e.g., as part of an E2E link establishment). As part of the relay operation, the source UE 115 may request for local (e.g., temporary) identifiers associated with the relay communications to be assigned to the source UE 115, the destination UE 115, or both. The local identifiers may facilitate a distinction between multiple E2E RBs, as described herein with reference to FIG. 2, as well as other advantages. In some examples, the relay UE 115 may determine the local identifiers. To transmit the local identifiers and associate them with the corresponding relay communications (e.g., for bearer mapping and routing), the relay communications may include an SRAP header 305 with the one or more of the local identifiers. The SRAP header 305 may be formatted according to various possible configurations that may be configured, preconfigured, or both. In some cases, the SRAP header 305 may be persistently formatted according to one of the various possible configurations.

In some cases, the SRAP header 305 may have a same configuration over both the first link between the source UE 115 and the relay UE 115 (e.g., a first hop) and the second link between the relay UE 115 and the destination UE 115 (e.g., a second hop). Additionally, or alternatively, the SRAP header 305 may have different configurations over the first link and the second link. In some examples, the SRAP header 305 may include identifiers similar to an SRAP of L2 U2N relay. For example, the SRAP header 305 may include an E2E sidelink DRB identifier (e.g., SLRB-PC5-ConfigIndex-r16) and a sidelink SRB identifier (e.g., SRB0, SRB1, SRB2, SRB3, etc.).

In the example of FIG. 3A, an SRAP header 305-a may represent a first possible configuration. The SRAP header 305-a may include an RB identifier 310, both local identifiers for the destination UE 115 and the source UE 115 (e.g., a destination UE identifier 315 and a source UE identifier 320 respectively), and other various resources (e.g., reserved resources). In some examples, the RB identifier 310 may take up nine codepoints (e.g., bits), the destination UE identifier 315 may take up eight codepoints, and the source UE identifier 320 may take up eight codepoints.

In the example of FIG. 3B, an SRAP header 305-b and an SRAP header 305-c may represent a second possible configuration. The SRAP header 305-b may include an RB identifier 310, a local identifier for the destination UE 115 (e.g., a destination UE identifier 315), a payload 325 associated with the relay communications, and other various resources (e.g., reserved resources). The SRAP header 305-c may include an RB identifier 310, a local identifier for the source UE 115 (e.g., a destination UE identifier 315), and other various resources (e.g., reserved resources). In some cases, the SRAP header 305-b may be associated with the first link while the SRAP header 305-c may be associated with the second link. For example, the relay UE 115 may identify the source UE 115 via another identifier (e.g., a L2 identifier in a MAC-CE and/or DCI) and so the SRAP header 305-b associated with the first link may not include the source UE identifier 320. The SRAP header 305-b, however, may include the destination UE identifier 315 so that the relay UE 115 may determine where to relay the relay communications. As the destination UE 115 may transmit a response to the source UE 115, the SRAP header 305-c may include the source UE identifier 320 and exclude the destination UE identifier 315. In some examples, the RB identifier 310 may take up nine codepoints (e.g., bits), the destination UE identifier 315 may take up eight codepoints, the source UE identifier 320 may take up eight codepoints, and the payload 325 may take up eight codepoints.

In the example of FIG. 3C, an SRAP header 305-d may represent a third possible configuration. The SRAP header 305-d may include an RB identifier 310, a single local identifier that identifies the destination UE 115 and the source UE 115 as a pair (e.g., an index pair 330), a payload 325 associated with the relay communications, and other various resources (e.g., reserved resources). For example, the index pair 330 may indicate both the destination UE 115 and the source UE 115. In some examples, the RB identifier 310 may take up nine codepoints (e.g., bits), the index pair 330 may take up five codepoints, and the payload 325 may take up eight codepoints.

While the different SRAP headers 305-a, 305-b, and 305-c utilize various codepoint configurations, it is to be understood that more codepoint configurations are possible. For example, the payload 325 may take up more or less than eight codepoints. Similarly, each of the other identifiers and fields of the SRAP headers 305 may differ from the FIGS. 3A, 3B, and 3C.

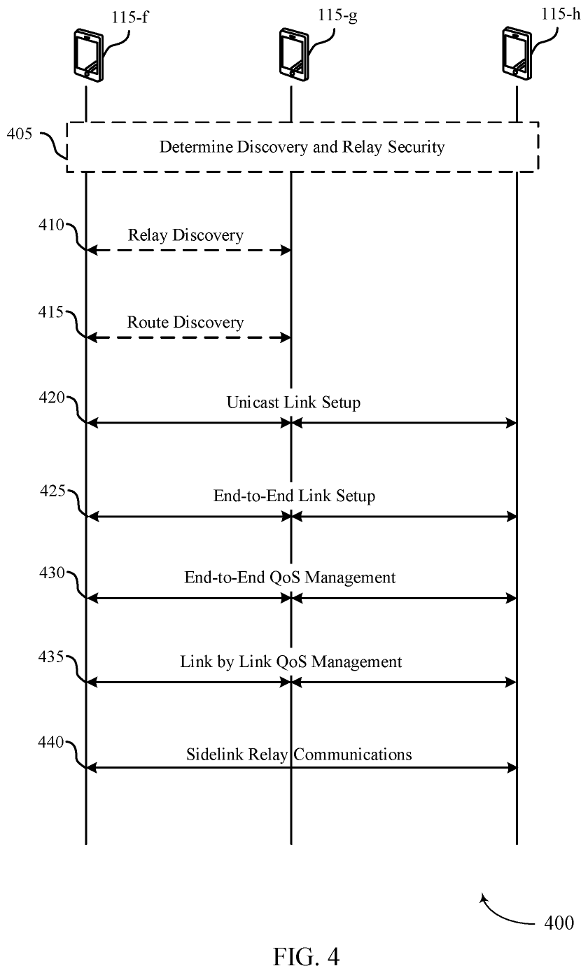

FIG. 4 illustrates an example of a process flow 400 that supports path management of a sidelink relay between user equipment in accordance with one or more aspects of the present disclosure. In some examples, the process flow 400 may implement or be implemented by aspects of the wireless communications systems 100 and 200 and the configurations 300 as described with reference to FIGS. 1-3. For example, the process flow 400 may be implemented by a UE 115-f, a UE 115-g, and a UE 115-h, which may be respective examples of a source UE 115, a relay UE 115, and a destination UE 115, as described with reference to FIGS. 1-3. In the following description of the process flow 400, the operations between the UE 115-f, the UE 115-g, and the UE 115-h may be transmitted in a different order than the example order shown, or the operations performed by the UE 115-f, the UE 115-g, and the UE 115-h may be performed in different orders or at different times. Some operations may also be omitted from the process flow 400, and other operations may be added to the process flow 400.

In some examples, a sidelink relay operation (e.g., a U2U relaying operation) may enable a coverage extension of sidelink transmissions between sidelink UEs 115. For example, the UE 115-h may be inaccessible to the UE 115-f for a direct link (e.g., due to distance, interference, etc.), the UEs 115 may be a part of a V2X operation that promotes using a relay UE 115 (e.g., the UE 115-g), or both, among other examples. In some examples, to facilitate communications between the UE 115-f and the UE 115-h a first link between the UE 115-f and the UE 115-g and a second link between the UE 115-g and the UE 115-h may be established, where the first link and the second link together may be an E2E link. However, some techniques do not support a procedure for E2E link establishment, path management, protocols, and multi-path relays associated with a U2U relaying operation. Because of the lack of support for E2E links associated with U2U relaying operation, the UE 115-f may not be able to communicate with the UE 115-h.

In order to facilitate E2E link and U2U relay operations, the UEs 115-f, 115-g, and 115-h may perform procedures associated with path management of a sidelink relay between the UEs 115-f, 115-g, and 115-h. For example, at 405, the UEs 115-f, 115-g, and 115-h may optionally determine discovery and relay security information (e.g., key material). In some cases associated with in-coverage and/or partial-coverage scenarios, a network entity 105 may provide the information to the UEs 115-f, 115-g, and 115-h (e.g., via a public key management function (PKMF)). In some other cases associated with out-of-coverage scenarios, the UEs 115-f, 115-g, and 115-h may be preconfigured with the information.

At 410, the UE 115-f and the UE 115-g may optionally perform a relay discovery procedure. At 415, the UE 115-f and the UE 115-g may optionally perform a route discovery and selection procedure. In some cases, the relay discovery procedure and the route discovery and selection procedure may include multiple transmissions and receptions associated with discovering a relay UE 115, discovering routes of communication, and selecting a route of communication from the routes of communication to perform the sidelink relay procedure.

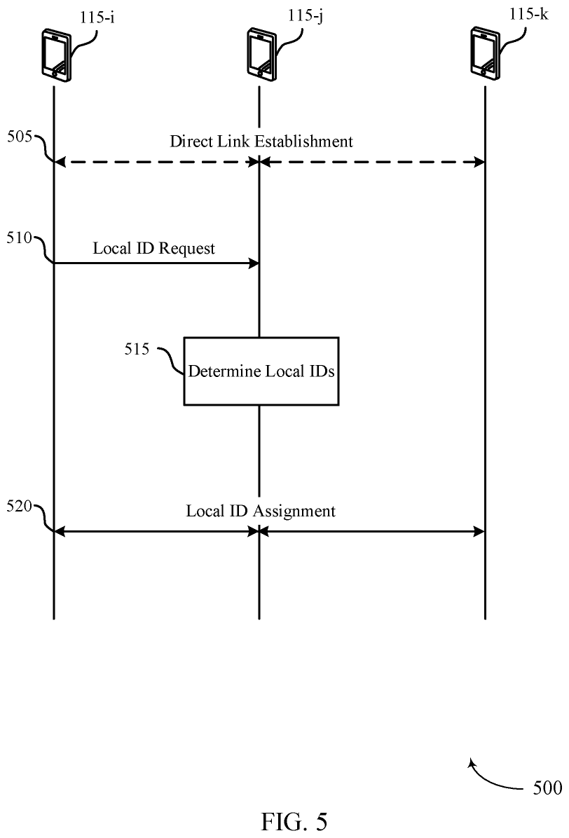

At 420, the UEs 115-f, 115-g, and 115-h may perform a unicast link setup procedure (e.g., a hop-by-hop unicast link setup), as described herein with reference to FIG. 5. In some cases, the unicast link setup may be an E2E unicast link setup from the UE 115-f to the UE 115-h. In some examples, the UE 115-g may represent multiple relay UEs 115 as part of a multi-hop relay operation.

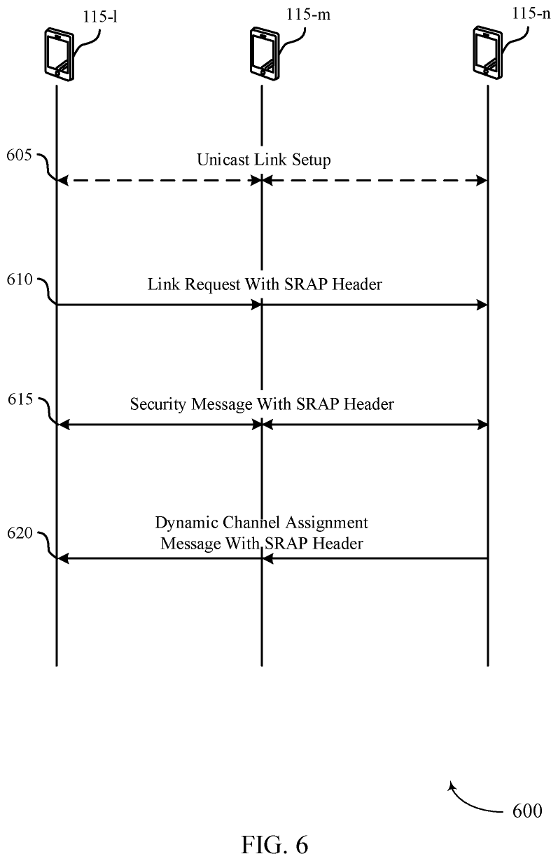

At 425, the UEs 115-f, 115-g, and 115-h may perform an E2E link setup, as described herein with reference to FIG. 6. In some cases, the E2E link setup may be an E2E PC5-S link setup.

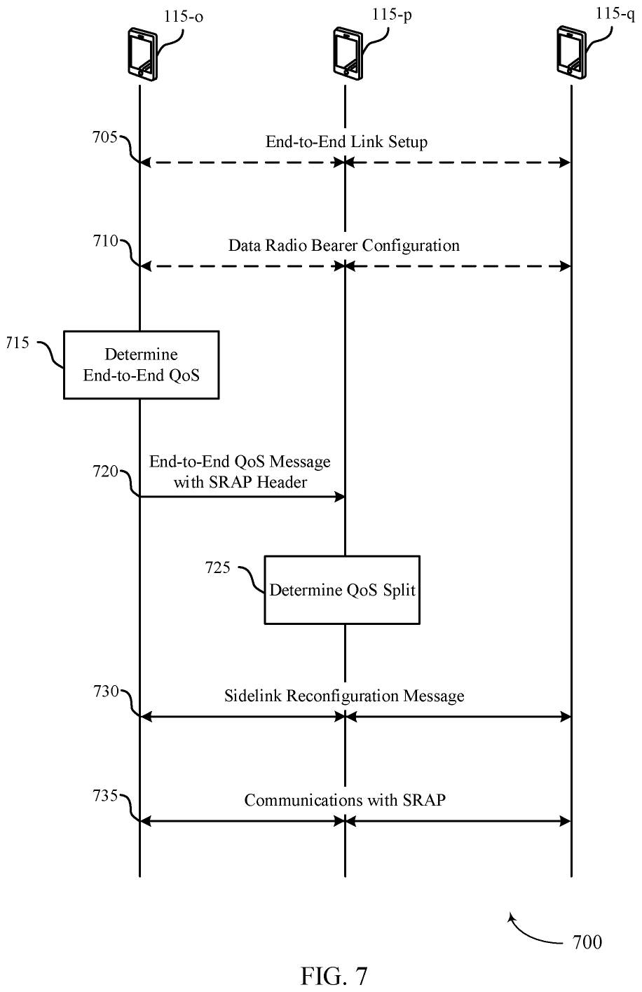

At 430, the UEs 115-f, 115-g, and 115-h may perform an E2E QoS management procedure and at 435 the UEs 115-f, 115-g, and 115-h may perform a link by link (e.g., hop-by-hop) QOS management procedure, as described with reference to FIG. 7. In some cases, the E2E QOS management procedure may be associated with QoS management for PC5 service data adaptation protocol (SDAP) and/or PDCP.

At 440, the UEs 115-f, 115-g, and 115-h may communicate sidelink communications in accordance with the sidelink relay procedure based on the E2E link.

FIG. 5 illustrates an example of a process flow 500 that supports path management of a sidelink relay between user equipment in accordance with one or more aspects of the present disclosure. In some examples, the process flow 500 may implement or be implemented by aspects of the wireless communications systems 100 and 200, the configurations 300, and the process flow 400, as described herein with reference to FIGS. 1-4. For example, the process flow 500 may be implemented by a UE 115-i, a UE 115-j, and a UE 115-k, which may be respective examples of a source UE 115, a relay UE 115, and a destination UE 115, as described with reference to FIGS. 1-4. In the following description of the process flow 500, the operations between the UE 115-i, the UE 115-j, and the UE 115-k may be transmitted in a different order than the example order shown, or the operations performed by the UE 115-i, the UE 115-j, and the UE 115-k may be performed in different orders or at different times. Some operations may also be omitted from the process flow 500, and other operations may be added to the process flow 500.

At 505, the UEs 115-i, 115-j, and 115-k may optionally perform a direct link establishment procedure. In some cases, the direct link establishment procedure may include the UE 115-I transmitting, to the UE 115-j, a request to establish a sidelink link (e.g., a ProSe direct link establishment request) that may include user information associated with the UE 115-i, user information associated with the UE 115-j, a relay service code (RSC), U2U relay target user information (e.g., UE 115-k user information), or any combination thereof. In some examples, the UE 115-j may set up a unicast link to the UE 115-k (e.g., if a unicast link is not available to reuse). In some cases, the direct link establishment procedure may also include one or more per hop authentication and key agreement, one or more ProSe direct link security mode command, one or more ProSe direct link security mode complete message, one or more ProSe direct link establishment accept messages, or any combination thereof.

At 510, the UE 115-i may transmit control signaling indicating a request for one or more temporary (local) identifications assigned to the UE 115-i, the UE 115-k, or both, for the sidelink relay operation. In some cases, the control signaling may include a PC5-RRC message. In some examples, the request may include a request for a local pair identifier, UE 115-k user information, a E2E L2 identifier associated with the UE 115-i and the UE 115-k (e.g., the E2E L2 identifier planned to be used for the pair), or any combination thereof.

At 515, the UE 115-j may determine the local identifiers. For example, the UE 115-j may assign a local identifier of the UE 115-k and the UE 115-i (e.g., during per hop link setup), which may facilitate a distinction between multiple E2E RBs, as described herein with reference to FIG. 2. The local identifiers may also support an SRAP header (e.g., an SRAP header associated with PC5-S messages), as described herein with reference to FIG. 3.

At 520, the UE 115-j may transmit signaling that includes the local identifiers to the UE 115-i, the UE 115-k, or both. In some cases, the UE 115-j may assign the local identifiers to the UE 115-i, the UE 115-k, or both, via a PC5-RRC message after PC5-S link setup (e.g., the UE 115-j may act similar to a domain name system (DNS) server for local identification assignment). In some examples, the signaling may include a PC5-RRC message with one or more of the different configurations 300 as described herein with reference to FIG. 3. For example, the different configurations 300 may include, both local identifiers of the UE 115-i and the UE 115-k provided to both the UE 115-i and the UE 115-k, an index of the pair (UE 115-i, UE 115-k) provided to both the UE 115-i and the UE 115-k, and/or the local identifier of the UE 115-i provided to the UE 115-k and the local identifier of the UE 115-k provided to the UE 115-j.

In some cases, the UE 115-i may represent one or more source UEs 115, as described herein with reference to FIG. 2 (e.g., UE 115-a and UE 115-b).

FIG. 6 illustrates an example of a process flow 600 that supports path management of a sidelink relay between user equipment in accordance with one or more aspects of the present disclosure. In some examples, the process flow 600 may implement or be implemented by aspects of the wireless communications systems 100 and 200, the configurations 300, and the process flows 400 and 500, as described herein with reference to FIGS. 1-5. For example, the process flow 600 may be implemented by a UE 115-1, a UE 115-m, and a UE 115-n, which may be respective examples of a source UE 115, a relay UE 115, and a destination UE 115, as described with reference to FIGS. 1-5. In the following description of the process flow 600, the operations between the UE 115-1, the UE 115-m, and the UE 115-n may be transmitted in a different order than the example order shown, or the operations performed by the UE 115-1, the UE 115-m, and the UE 115-n may be performed in different orders or at different times. Some operations may also be omitted from the process flow 600, and other operations may be added to the process flow 600. The operations depicted may be associated with communicating (e.g., transmitting, relaying, receiving, etc.) one or more messages associated with establishing an E2E link of a set of E2E links between the UE 115-1 and the UE 115-n.

At 605, the UEs 115-1, 115-m, and 115-n may optionally perform a unicast link setup, as described herein with reference to FIG. 5. At 610, the UE 115-1 may transmit, to the UE 115-m, a link request. In some cases, the link request may include at least an SRAP header according to one of the SRAP header configurations 305, as described herein with reference to FIG. 3. In some examples, the link request may include source user information associated with the UE 115-1 and target user information associated with the UE 115-n. The UE 115-m may relay the link request including the SRAP header to the UE 115-n.

At 615, the UEs 115-1, 115-m, and 115-n may perform a security establishment procedure. For example, the UEs 115-1, 115-m, and 115-n may communicate (e.g., transmit, relay, and/or receive) a security message that includes the SRAP header. In some cases, the security message may include security for the E2E PC5-S and the UEs 115-1, 115-m, and 115-n may establish the E2E PC5-S security via a sidelink SRB1.

At 620, the UE 115-n may transmit, to the UE 115-m, a dynamic channel assignment message. In some cases, the dynamic channel assignment message may include at least the SRAP header. In some examples, the dynamic channel assignment message may include source user information associated with the UE 115-n and target user information associated with the UE 115-1. The UE 115-m may relay the dynamic channel assignment message including the SRAP header to the UE 115-1.

In some examples, the UEs 115-1, 115-m, and 115-n may reuse one or more ProSe direct PC5-S messages for the E2E link setup (e.g., E2E PC5-S link setup). In some cases, an E2E sidelink SRB0 through SRB3 may be configured based on a default configuration (e.g., a preconfiguration, a configuration from a network entity 105, etc.). In some cases, the UE 115-m may establish one or more sidelink RLC channels for SRBs based on a default configuration. In some examples, the UE 115-m may perform routing based on one or more of the local identifiers included in the SRAP header. In some cases, the SRAP header may not impact the L2 identifier used in the MAC/PHY layers (e.g., hop-by-hop).

FIG. 7 illustrates an example of a process flow 700 that supports path management of a sidelink relay between user equipment in accordance with one or more aspects of the present disclosure. In some examples, the process flow 700 may implement or be implemented by aspects of the wireless communications systems 100 and 200, the configurations 300, and the process flows 400, 500, and 600, as described herein with reference to FIGS. 1-6. For example, the process flow 700 may be implemented by a UE 115-o, a UE 115-p, and a UE 115-q, which may be respective examples of a source UE 115, a relay UE 115, and a destination UE 115, as described with reference to FIGS. 1-6. In the following description of the process flow 700, the operations between the UE 115-0, the UE 115-p, and the UE 115-q may be transmitted in a different order than the example order shown, or the operations performed by the UE 115-o, the UE 115-p, and the UE 115-q may be performed in different orders or at different times. Some operations may also be omitted from the process flow 700, and other operations may be added to the process flow 700. The operations depicted may be associated with communicating (e.g., transmitting, relaying, receiving, etc.) one or more messages associated with an AS procedure.

At 705, the UEs 115-0, 115-p, and 115-q may optionally perform an E2E link setup, as described herein with reference to FIG. 6. At 710, the UEs 115-o may optionally perform a DRB configuration procedure. In some cases, the DRB configuration procedure may include an RRC reconfiguration message (e.g., a RRCReconfiguationSidelink and/or a RRCReconfigurationComplete message) and an E2E sidelink DRB configuration (e.g., SDAP and/or PDCP).

At 715, the UE 115-o may determine and/or change a QoS (e.g., an E2E PC5 QoS). Based on the determination, at 720, the UE 115-o may transmit, to the UE 115-p, a QoS message. In some cases, the QoS message may be an E2E QoS message that includes at least an SRAP header. The QoS message may also include a sidelink RB PC5 index (e.g., SLRB-PC5-ConfigIndex) and the E2E QoS. In some examples, the QoS message may be included in a PC5 RRC message.

At 725, the UE 115-p may determine a QoS split based on the QoS message. For example, the UE 115-p may determine a relaying RLC configuration in multiple (e.g., two) hops according to the QoS message. In some cases, the QoS split may be a split of the E2E QoS where a first portion may be associated with a first link between the UE 115-o and the UE 115-p and a second portion may be associated with a second link between the UE 115-p and the UE 115-q. In some examples, the QoS split may be based on a mapping from a network entity 105 (e.g., an access and mobility management function (AMF)). In some cases, the UE 115-p may configure lower layer configurations (e.g., MAC/PHY layers) for the UE 115-o and the UE 115-q in parallel based on the QoS split.

At 730, the UE 115-p may transmit (relay) to the UE 115-0, the UE 115-q, or both, a sidelink reconfiguration message. In some cases, the sidelink reconfiguration message may include an RRC reconfiguration message (e.g., a RRCReconfiguationSidelink and/or a RRCReconfigurationComplete message); an SRAP header; a sidelink RLC channel setup packet delay budget (PDB); a sidelink RB PC5 index (e.g., SLRB-PC5-ConfigIndex); one or more updated local identifiers for the UE 115-o, the UE 115-q, or both; or any combination thereof. In some cases, the UE 115-p may configure the PC5 RLC channel for multiple (e.g., two) hops, the split PDB for multiple (e.g., two) hops, the updated local identifiers (if necessary), or any combination thereof, via a PC5 RRC message.

At 735, the UEs 115-0, 115-p, and 115-q may communicate sidelink communications (e.g., uplink and downlink data transmissions with PC5 SRAP layer) in accordance with the sidelink relay procedure based on the E2E link.

FIG. 8 illustrates an example of a process flow 800 that supports path management of a sidelink relay between user equipment in accordance with one or more aspects of the present disclosure. In some examples, the process flow 800 may implement or be implemented by aspects of the wireless communications systems 100 and 200, the configurations 300, and the process flows 400, 500, 600, and 700, as described herein with reference to FIGS. 1-7. For example, the process flow 800 may be implemented by a UE 115-r, a UE 115-s, and a UE 115-t, which may be respective examples of a source UE 115, a relay UE 115, and a destination UE 115, as described with reference to FIGS. 1-7. In the following description of the process flow 800, the operations between the UE 115-r, the UE 115-s, and the UE 115-t may be transmitted in a different order than the example order shown, or the operations performed by the UE 115-r, the UE 115-s, and the UE 115-t may be performed in different orders or at different times. Some operations may also be omitted from the process flow 800, and other operations may be added to the process flow 800. The operations depicted may be associated with determining an RLF and performing a relay reselection.

In some cases, the UE 115-r may determine to establish multiple E2E links as part of a multi-path relay operation, as described herein with reference to FIG. 2. The UE 115-r may determine whether to release a first link between the UE 115-r and the UE 115-s based on a performance indication associated with the first link, a second link between the UE 115-s and the UE 115-t, or both. For example, the UE 115-r may determine to release the first link (e.g., a unicast PC5 link with a relay UE 115) and trigger a relay reselection based on sidelink measurements (e.g., sidelink reference signal received power (SL-RSRP) and/or sidelink discovery RSRP (SD-RSRP)) associated with the UE 115-s being below a threshold, detection of an RLF (e.g., a PC5 RLF) associated with the UE 115-s, reception of signaling (e.g., PC5-S) for a release procedure (e.g., L2 release) from the UE 115-s, or any combination thereof.

In some cases, the UE 115-r may determine whether to perform a path management procedure (e.g., release the first link or reconfigure multiplexing) based on a reception of control signaling (e.g., PC5 RRC message) that indicates an RLF (e.g., PC5 RLF) that was detected on the second link (e.g., a PC5 link between a relay UE 115 and a destination UE 115), reception of control signaling (e.g., PC5 RRC message) that indicates one or more sidelink measurements (e.g., SL-RSRP and/or SD-RSRP) associated with the second link are below a threshold, or both.

At 805, the UEs 115-r, 115-s, and 115-t may be communicating (e.g., transmitting, relaying, receiving, etc.) based on a sidelink relay procedure. In some cases, the UE 115-s may optionally detect an RLF (e.g., PC5 RLD) associated with the first link, the second link, or both, and notify, the UE 115-t or the UE 115-r respectively. Additionally, or alternatively, the UE 115-r, the UE 115-t, or both may detect the RLF and notify (e.g., transmit a message indicating) the UE 115-s.

At 810, the UE 115-r may optionally determine a performance indication based on (a) the detected RLF of the first link and/or the second link; (b) sidelink measurements associated with the first link, the second link, or both; or a combination of (a) and (b). For example, the UE 115-r may determine that the sidelink measurements associated with the first link, the second link, or both, are below a sidelink threshold. In some cases, the sidelink threshold may be configured (e.g., by a network entity 105), preconfigured, or both. In some examples, at 815, the UE 115-s may optionally determine a performance indication based on (a) the detected RLF of the first link and/or the second link; (b) sidelink measurements associated with the first link, the second link, or both; or a based on a combination of (a) and (b).

At 820, the UE 115-s may optionally transmit, to the UE 115-t, a release message based on the performance indication. The release message may indicate to the UE 115-t that the first link has been or will be released. At 830, the UE 115-s may optionally transmit, to the UE 115-r, a release message based on the performance indication. The release message may indicate to the UE 115-r that the second link has been or will be released.

At 825, the UEs 115-s and UE 115-t may perform a path management procedure. The path management procedure may include releasing the first link, the second link, or both and/or reconfiguring multiplexing of the first link, the second link, or both.

At 835, the UE 115-r may release the first link (e.g., a sidelink link) and determine to perform a reselection procedure based on the performance indication (e.g., a PC5 RLF detection and/or a notification from the UE 115-s). The UE 115-r may determine a set of E2E links that are dormant. For example, the UE 115-r may have established multiple E2E PC5-S links besides the active E2E link (e.g., the first link and the second link combined) with the UE 115-t. In some cases the set of E2E links may not include E2E PC5 RRC links.

At 840, the UE 115-r may select another available E2E link (e.g., an E2E PC5-S link) of the set of E2E links (e.g., dormant links) to initiate E2E link establishment (e.g., E2E PC5 link establishment). In some cases, the UE 115-r may initiate the reselection procedure upon determining to release the first link. The reselection procedure may include deactivating the E2E link associated with the first link, the second link, and the UE 115-s, activating a second E2E link of the set of E2E links, and communicating over the second E2E link.

In some examples, the UE 115-r may select the E2E link based on a value of one or more sidelink measurements (e.g., best SL-RSRP and/or SD-RSRP associated with a first hop), a minimum value of one or more sidelink measurements (e.g., best of min (SL-RSRP/SD-RSRP of first hop, SL-RSRP/SD-RSRP of second hop)), a mean value of one or more sidelink measurements (e.g., best of mean (SL-RSRP/SD-RSRP of first hop, SL-RSRP/SD-RSRP of second hop)), or any combination thereof. In some cases, the sidelink measurements may be associated with a third link and/or a fourth link of the selected E2E link, where the UE 115-r may communicate with another relay UE 115, different than the UE 115-s, associated with the selected E2E link.

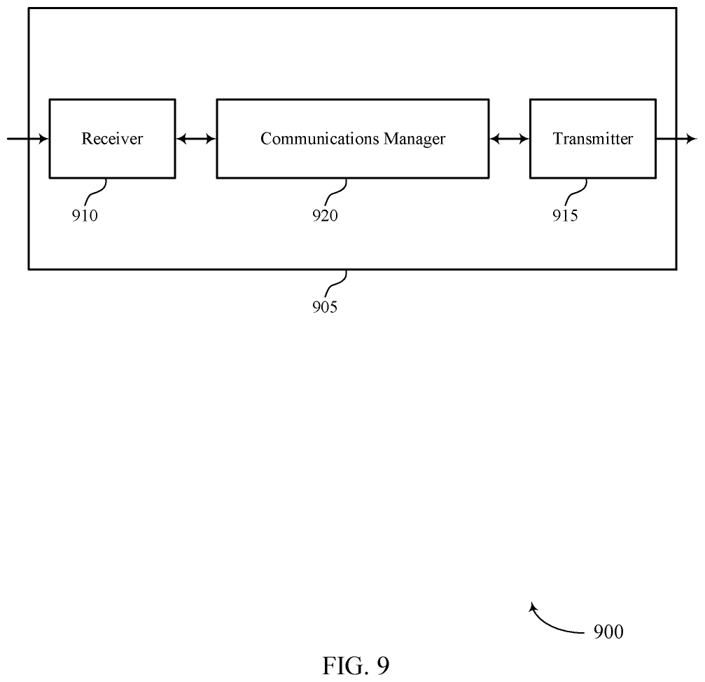

FIG. 9 shows a block diagram 900 of a device 905 that supports path management of a sidelink relay between user equipment in accordance with one or more aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to path management of a sidelink relay between user equipment). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to path management of a sidelink relay between user equipment). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of path management of a sidelink relay between user equipment as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a first UE in accordance with examples as disclosed herein. For example, the communications manager 920 may be configured as or otherwise support a means for relaying communications between one or more second UEs and a third UE based on a sidelink relay operation where the relaying includes communicating with the one or more second UEs over a first link and communicating with the third UE over a second link. The communications manager 920 may be configured as or otherwise support a means for receiving, from the one or more second UEs, control signaling indicating a request for one or more temporary identifications assigned to the one or more second UEs, the third UE, or both, for the sidelink relay operation. The communications manager 920 may be configured as or otherwise support a means for transmitting signaling including a SRAP header to the one or more second UEs and the third UE, where the SRAP header includes the one or more temporary identifications.

Additionally, or alternatively, the communications manager 920 may support wireless communication at a second UE in accordance with examples as disclosed herein. For example, the communications manager 920 may be configured as or otherwise support a means for communicating with a first UE over a first link based on a sidelink relay operation between the second UE and a third UE. The communications manager 920 may be configured as or otherwise support a means for transmitting, to the first UE, control signaling indicating a request for one or more temporary identifications assigned to the second UE, the third UE, or both, for the sidelink relay operation. The communications manager 920 may be configured as or otherwise support a means for receiving signaling including a SRAP header, where the SRAP header includes the one or more temporary identifications.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for more efficient V2X operations, more flexible sidelink communications, and more efficient use of resources.

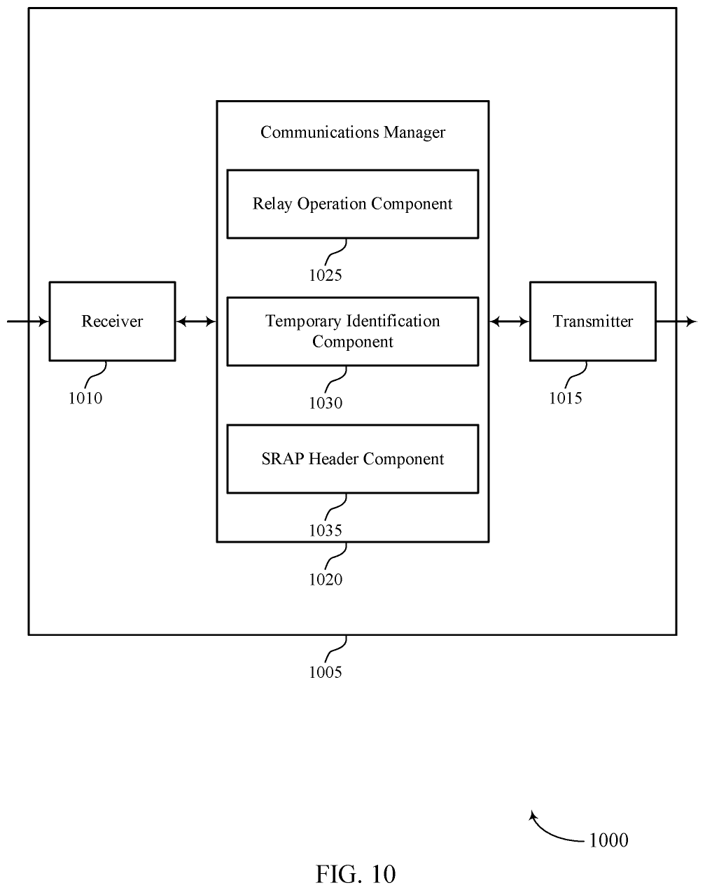

FIG. 10 shows a block diagram 1000 of a device 1005 that supports path management of a sidelink relay between user equipment in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to path management of a sidelink relay between user equipment). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to path management of a sidelink relay between user equipment). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of path management of a sidelink relay between user equipment as described herein. For example, the communications manager 1020 may include a relay operation component 1025, a temporary identification component 1030, an SRAP header component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a first UE in accordance with examples as disclosed herein. The relay operation component 1025 may be configured as or otherwise support a means for relaying communications between one or more second UEs and a third UE based on a sidelink relay operation where the relaying includes communicating with the one or more second UEs over a first link and communicating with the third UE over a second link. The temporary identification component 1030 may be configured as or otherwise support a means for receiving, from the one or more second UEs, control signaling indicating a request for one or more temporary identifications assigned to the one or more second UEs, the third UE, or both, for the sidelink relay operation. The SRAP header component 1035 may be configured as or otherwise support a means for transmitting signaling including a SRAP header to the one or more second UEs and the third UE, where the SRAP header includes the one or more temporary identifications.

Additionally, or alternatively, the communications manager 1020 may support wireless communication at a second UE in accordance with examples as disclosed herein. The relay operation component 1025 may be configured as or otherwise support a means for communicating with a first UE over a first link based on a sidelink relay operation between the second UE and a third UE. The temporary identification component 1030 may be configured as or otherwise support a means for transmitting, to the first UE, control signaling indicating a request for one or more temporary identifications assigned to the second UE, the third UE, or both, for the sidelink relay operation. The SRAP header component 1035 may be configured as or otherwise support a means for receiving signaling including a SRAP header, where the SRAP header includes the one or more temporary identifications.

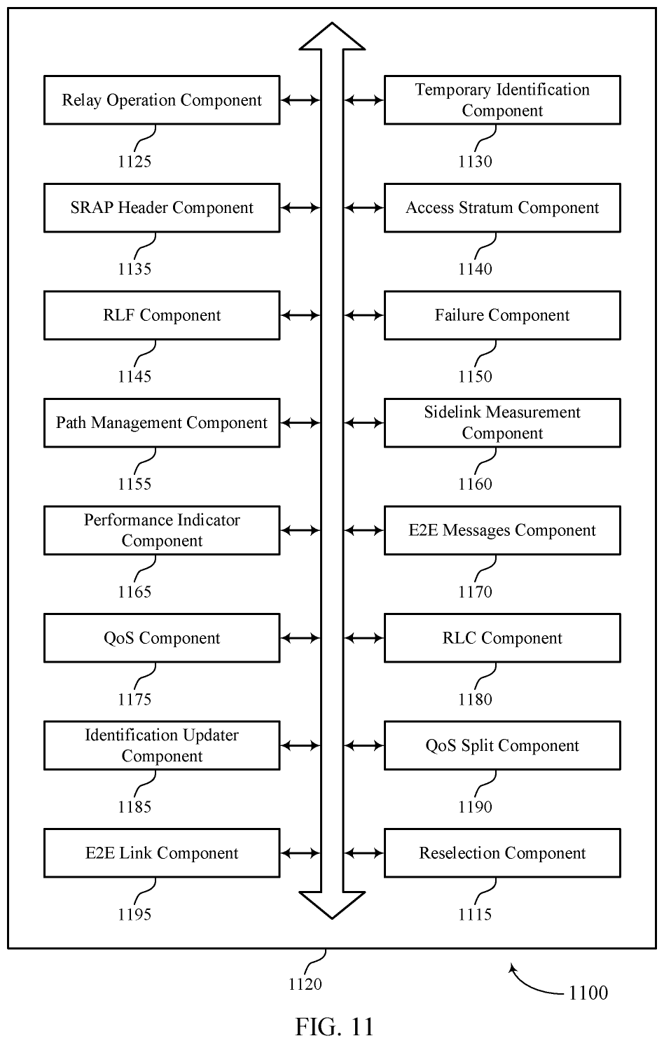

FIG. 11 shows a block diagram 1100 of a communications manager 1120 that supports path management of a sidelink relay between user equipment in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of path management of a sidelink relay between user equipment as described herein. For example, the communications manager 1120 may include a relay operation component 1125, a temporary identification component 1130, an SRAP header component 1135, an AS component 1140, an RLF component 1145, a failure component 1150, a path management component 1155, a sidelink measurement component 1160, a performance indicator component 1165, a E2E messages component 1170, a QoS component 1175, an RLC component 1180, an identification updater component 1185, a QoS split component 1190, a E2E link component 1195, a reselection component 1115, or any combination thereof. Each of these components may communicate, directly or indirectly, with one another (e.g., via one or more buses).

The communications manager 1120 may support wireless communication at a first UE in accordance with examples as disclosed herein. The relay operation component 1125 may be configured as or otherwise support a means for relaying communications between one or more second UEs and a third UE based on a sidelink relay operation where the relaying includes communicating with the one or more second UEs over a first link and communicating with the third UE over a second link. The temporary identification component 1130 may be configured as or otherwise support a means for receiving, from the one or more second UEs, control signaling indicating a request for one or more temporary identifications assigned to the one or more second UEs, the third UE, or both, for the sidelink relay operation. The SRAP header component 1135 may be configured as or otherwise support a means for transmitting signaling including a SRAP header to the one or more second UEs and the third UE, where the SRAP header includes the one or more temporary identifications.

In some examples, the temporary identification component 1130 may be configured as or otherwise support a means for transmitting the one or more temporary identifications assigned to the one or more second UEs, the third UE, or both, to the one or more second UEs, the third UE, or both, based on the control signaling.

In some examples, to support transmitting the signaling, the SRAP header component 1135 may be configured as or otherwise support a means for relaying one or more messages associated with establishing an E2E link of a set of E2E links between the one or more second UEs and the third UE based on the sidelink relay operation, where the one or more messages include the SRAP header.

In some examples, a link request, a security message, a dynamic channel assignment message, or any combination thereof.

In some examples, to support transmitting the signaling, the AS component 1140 may be configured as or otherwise support a means for relaying one or more messages associated with an AS procedure, where the one or more messages include the SRAP header.

In some examples, to support relaying the one or more messages, the QoS component 1175 may be configured as or otherwise support a means for receiving a QoS message associated with the first link and the second link based on the AS procedure, where the one or more messages includes the QoS message. In some examples, to support relaying the one or more messages, the RLC component 1180 may be configured as or otherwise support a means for relaying a sidelink RLC channel message, where the sidelink RLC channel message is determined based on the QoS message. In some examples, to support relaying the one or more messages, the identification updater component 1185 may be configured as or otherwise support a means for relaying one or more updated temporary identifications assigned to the one or more second UEs, the third UE, or both, based on the QoS message. In some examples, to support relaying the one or more messages, the QoS split component 1190 may be configured as or otherwise support a means for determining a QoS split based on the QoS message.

In some examples, a PC5 RRC message, one or more RRC reconfiguration sidelink messages, or any combination thereof.

In some examples, the temporary identification component 1130 may be configured as or otherwise support a means for determining a first temporary identification assigned to the one or more second UEs, a second temporary identification assigned to the third UE, a temporary identification index pair associated with the one or more second UEs and the third UE, an RB identification associated with the sidelink relay operation, or any combination thereof, based on the control signaling, where the SRAP header includes the first temporary identification, the second temporary identification, the temporary identification index pair, the RB identification, or any combination thereof.

In some examples, the RLF component 1145 may be configured as or otherwise support a means for determining an RLF on the first link or the second link, where the first link and the second link are associated with a first E2E link of a set of E2E links. In some examples, the failure component 1150 may be configured as or otherwise support a means for transmitting a failure message to the one or more second UEs or the third UE based on the determining the RLF. In some examples, the path management component 1155 may be configured as or otherwise support a means for communicating with the third UE based on a path management procedure, where the path management procedure includes multiplexing reconfiguration or releasing the first link.

In some examples, to support transmitting the failure message, the failure component 1150 may be configured as or otherwise support a means for transmitting the failure message to the one or more second UEs based on the RLF being associated with the second link. In some examples, to support transmitting the failure message, the failure component 1150 may be configured as or otherwise support a means for transmitting the failure message to the third UE based on the RLF being associated with the first link.

In some examples, the sidelink measurement component 1160 may be configured as or otherwise support a means for determining a sidelink measurement associated with the first link is below a threshold, where the threshold is configured, preconfigured, or both. In some examples, the path management component 1155 may be configured as or otherwise support a means for communicating with the third UE based on a path management procedure, where the path management procedure includes multiplexing reconfiguration or releasing the first link.

In some examples, the control signaling includes a PC5 RRC message and the first link and the second link include an E2E PC5 sidelink link.

Additionally, or alternatively, the communications manager 1120 may support wireless communication at a second UE in accordance with examples as disclosed herein. In some examples, the relay operation component 1125 may be configured as or otherwise support a means for communicating with a first UE over a first link based on a sidelink relay operation between the second UE and a third UE. In some examples, the temporary identification component 1130 may be configured as or otherwise support a means for transmitting, to the first UE, control signaling indicating a request for one or more temporary identifications assigned to the second UE, the third UE, or both, for the sidelink relay operation. In some examples, the SRAP header component 1135 may be configured as or otherwise support a means for receiving signaling including a SRAP header, where the SRAP header includes the one or more temporary identifications.

In some examples, the temporary identification component 1130 may be configured as or otherwise support a means for receiving the one or more temporary identifications assigned to the second UE, the third UE, or both, from the first UE based on the control signaling.

In some examples, to support receiving the signaling, the SRAP header component 1135 may be configured as or otherwise support a means for communicating one or more messages associated with establishing a set of E2E links between the second UE and the third UE based on the sidelink relay operation, where the one or more messages include one or more SRAP headers.

In some examples, the E2E link component 1195 may be configured as or otherwise support a means for determining that an E2E link of the set of E2E links associated with the first UE is active, where other E2E links of the set of E2E links are inactive.

In some examples, the one or more SRAP headers include a different SRAP header associated with each E2E link of the set of E2E links. In some examples, the one or more messages include a link request, a security message, a dynamic channel assignment message, or any combination thereof.

In some examples, to support receiving the signaling, the AS component 1140 may be configured as or otherwise support a means for communicating one or more messages associated with an AS procedure, where the one or more messages include the SRAP header.

In some examples, to support communicating the one or more messages, the QoS component 1175 may be configured as or otherwise support a means for transmitting a QoS message associated with the first link and a second link, where the second link is associated with the sidelink relay operation, and where the one or more messages includes the QoS message. In some examples, to support communicating the one or more messages, the RLC component 1180 may be configured as or otherwise support a means for receiving a sidelink RLC channel message, where the sidelink RLC channel message is determined based on the QoS message. In some examples, to support communicating the one or more messages, the identification updater component 1185 may be configured as or otherwise support a means for receiving one or more updated temporary identifications assigned to the second UE, the third UE, or both, based on the QoS message.

In some examples, a PC5 RRC message, one or more RRC reconfiguration sidelink messages, or both.

In some examples, the temporary identification component 1130 may be configured as or otherwise support a means for determining a first temporary identification assigned to the second UE, a second temporary identification assigned to the third UE, a temporary identification index pair associated with the second UE and the third UE, an RB identification associated with the sidelink relay operation, or any combination thereof, based on the SRAP header.

In some examples, the performance indicator component 1165 may be configured as or otherwise support a means for determining whether to release the first link based on a performance indication associated with the first link, a second link, or both, where the first link and the second link are associated with a first E2E link of a set of E2E links.

In some examples, the RLF component 1145 may be configured as or otherwise support a means for receiving a failure message from the first UE based on a RLF associated with the second link, where the performance indication includes the failure message. In some examples, the path management component 1155 may be configured as or otherwise support a means for communicating with the first UE based on a path management procedure, where the path management procedure includes multiplexing reconfiguration or releasing the first link.

In some examples, the sidelink measurement component 1160 may be configured as or otherwise support a means for determining a sidelink measurement associated with the first link is below a threshold, where the threshold is configured, preconfigured, or both, and the performance indication is indicative of the first link being below the threshold. In some examples, the path management component 1155 may be configured as or otherwise support a means for communicating with the first UE based on a path management procedure, where the path management procedure includes multiplexing reconfiguration or releasing the first link.

In some examples, the reselection component 1115 may be configured as or otherwise support a means for communicating with a fourth UE associated with a second E2E link of the set of E2E links based on a reselection procedure, where a start of the reselection procedure is based on the determining whether to release the first link.

In some examples, to support reselection procedure, the reselection component 1115 may be configured as or otherwise support a means for deactivating the first E2E link. In some examples, to support reselection procedure, the sidelink measurement component 1160 may be configured as or otherwise support a means for activating the second E2E link, where the second E2E link is determined based on sidelink measurements associated with a third link of the second E2E link, a fourth link of the second E2E link, or both. In some examples, to support reselection procedure, the E2E link component 1195 may be configured as or otherwise support a means for communicating one or more messages associated with establishing the second E2E link based on the activating the second E2E link.

In some examples, a minimum value of an SL-RSRP, an SD-RSRP, or both, associated with the third link and the fourth link. In some examples, a mean value of a SL-RSRP, a SD-RSRP, or both, associated with the third link and the fourth link. In some examples, a value of a SL-RSRP, a SD-RSRP, or both, associated with the third link.

In some examples, the control signaling includes a PC5 RRC message and the first link and a second link associated with the sidelink relay operation include an E2E PC5 sidelink link.

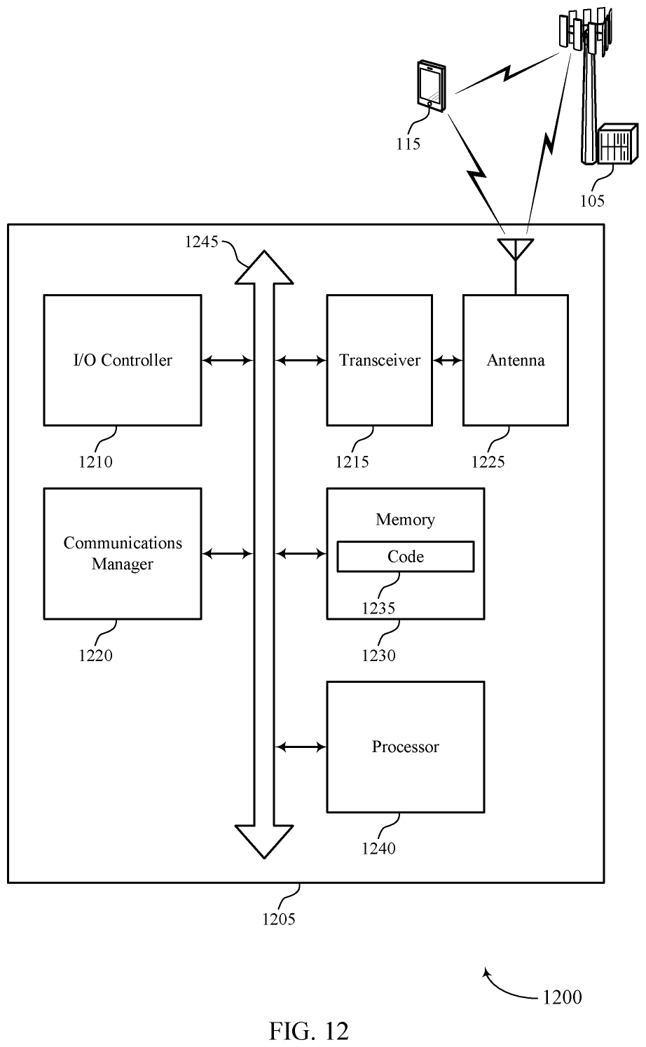

FIG. 12 shows a diagram of a system 1200 including a device 1205 that supports path management of a sidelink relay between user equipment in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting path management of a sidelink relay between user equipment). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communication at a first UE in accordance with examples as disclosed herein. For example, the communications manager 1220 may be configured as or otherwise support a means for relaying communications between one or more second UEs and a third UE based on a sidelink relay operation where the relaying includes communicating with the one or more second UEs over a first link and communicating with the third UE over a second link. The communications manager 1220 may be configured as or otherwise support a means for receiving, from the one or more second UEs, control signaling indicating a request for one or more temporary identifications assigned to the one or more second UEs, the third UE, or both, for the sidelink relay operation. The communications manager 1220 may be configured as or otherwise support a means for transmitting signaling including a SRAP header to the one or more second UEs and the third UE, where the SRAP header includes the one or more temporary identifications.

Additionally, or alternatively, the communications manager 1220 may support wireless communication at a second UE in accordance with examples as disclosed herein. For example, the communications manager 1220 may be configured as or otherwise support a means for communicating with a first UE over a first link based on a sidelink relay operation between the second UE and a third UE. The communications manager 1220 may be configured as or otherwise support a means for transmitting, to the first UE, control signaling indicating a request for one or more temporary identifications assigned to the second UE, the third UE, or both, for the sidelink relay operation. The communications manager 1220 may be configured as or otherwise support a means for receiving signaling including a SRAP header, where the SRAP header includes the one or more temporary identifications.

By including or configuring the communications manager 1220 in accordance with examples as described herein, the device 1205 may support techniques for more efficient V2X operations, more flexible sidelink communications, and more efficient use of resources

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of path management of a sidelink relay between user equipment as described herein, or the processor 1240 and the memory 1230 may be otherwise configured to perform or support such operations.

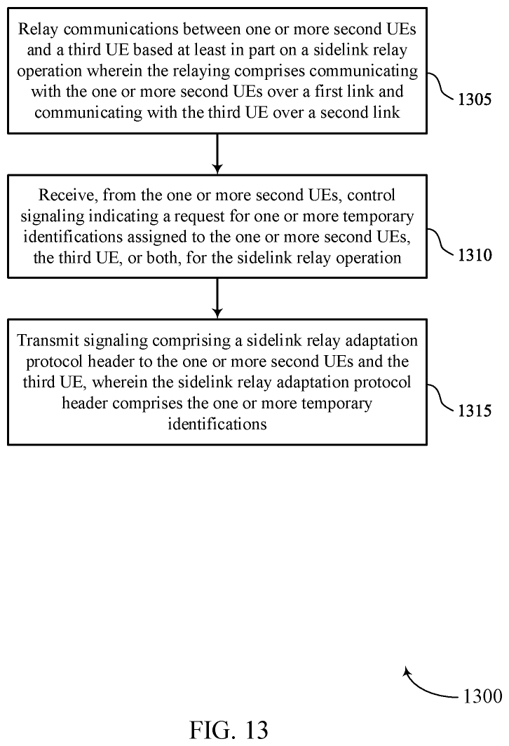

FIG. 13 shows a flowchart illustrating a method 1300 that supports path management of a sidelink relay between user equipment in accordance with one or more aspects of the present disclosure. The operations of the method 1300 may be implemented by a UE or its components as described herein. For example, the operations of the method 1300 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1305, the method may include relaying communications between one or more second UEs and a third UE based on a sidelink relay operation where the relaying includes communicating with the one or more second UEs over a first link and communicating with the third UE over a second link. The operations of 1305 may be performed in accordance with examples as disclosed herein. In some examples, aspects of the operations of 1305 may be performed by a relay operation component 1125 as described with reference to FIG. 11.

At 1310, the method may include receiving, from the one or more second UEs, control signaling indicating a request for one or more temporary identifications assigned to the one or more second UEs, the third UE, or both, for the sidelink relay operation. The operations of 1310 may be performed in accordance with examples as disclosed herein. In some examples, aspects of the operations of 1310 may be performed by a temporary identification component 1130 as described with reference to FIG. 11.

At 1315, the method may include transmitting signaling including a SRAP header to the one or more second UEs and the third UE, where the SRAP header includes the one or more temporary identifications. The operations of 1315 may be performed in accordance with examples as disclosed herein. In some examples, aspects of the operations of 1315 may be performed by an SRAP header component 1135 as described with reference to FIG. 11.

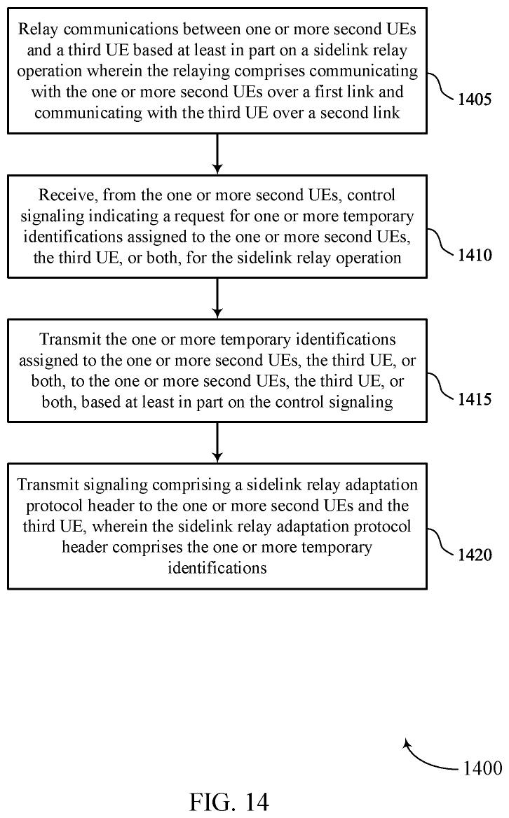

FIG. 14 shows a flowchart illustrating a method 1400 that supports path management of a sidelink relay between user equipment in accordance with one or more aspects of the present disclosure. The operations of the method 1400 may be implemented by a UE or its components as described herein. For example, the operations of the method 1400 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1405, the method may include relaying communications between one or more second UEs and a third UE based on a sidelink relay operation where the relaying includes communicating with the one or more second UEs over a first link and communicating with the third UE over a second link. The operations of 1405 may be performed in accordance with examples as disclosed herein. In some examples, aspects of the operations of 1405 may be performed by a relay operation component 1125 as described with reference to FIG. 11.

At 1410, the method may include receiving, from the one or more second UEs, control signaling indicating a request for one or more temporary identifications assigned to the one or more second UEs, the third UE, or both, for the sidelink relay operation. The operations of 1410 may be performed in accordance with examples as disclosed herein. In some examples, aspects of the operations of 1410 may be performed by a temporary identification component 1130 as described with reference to FIG. 11.

At 1415, the method may include transmitting the one or more temporary identifications assigned to the one or more second UEs, the third UE, or both, to the one or more second UEs, the third UE, or both, based on the control signaling. The operations of 1415 may be performed in accordance with examples as disclosed herein. In some examples, aspects of the operations of 1415 may be performed by a temporary identification component 1130 as described with reference to FIG. 11.

At 1420, the method may include transmitting signaling including a SRAP header to the one or more second UEs and the third UE, where the SRAP header includes the one or more temporary identifications. The operations of 1420 may be performed in accordance with examples as disclosed herein. In some examples, aspects of the operations of 1420 may be performed by an SRAP header component 1135 as described with reference to FIG. 11.

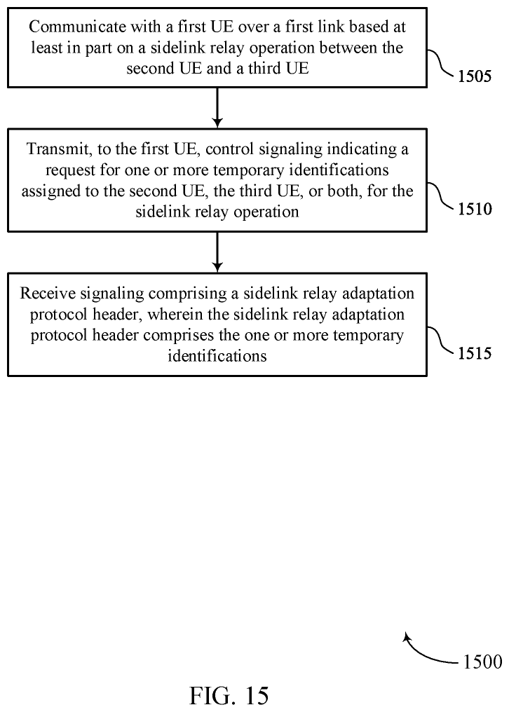

FIG. 15 shows a flowchart illustrating a method 1500 that supports path management of a sidelink relay between user equipment in accordance with one or more aspects of the present disclosure. The operations of the method 1500 may be implemented by a UE or its components as described herein. For example, the operations of the method 1500 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1505, the method may include communicating with a first UE over a first link based on a sidelink relay operation between the second UE and a third UE. The operations of 1505 may be performed in accordance with examples as disclosed herein. In some examples, aspects of the operations of 1505 may be performed by a relay operation component 1125 as described with reference to FIG. 11.

At 1510, the method may include transmitting, to the first UE, control signaling indicating a request for one or more temporary identifications assigned to the second UE, the third UE, or both, for the sidelink relay operation. The operations of 1510 may be performed in accordance with examples as disclosed herein. In some examples, aspects of the operations of 1510 may be performed by a temporary identification component 1130 as described with reference to FIG. 11.

At 1515, the method may include receiving signaling including a SRAP header, where the SRAP header includes the one or more temporary identifications. The operations of 1515 may be performed in accordance with examples as disclosed herein. In some examples, aspects of the operations of 1515 may be performed by an SRAP header component 1135 as described with reference to FIG. 11.

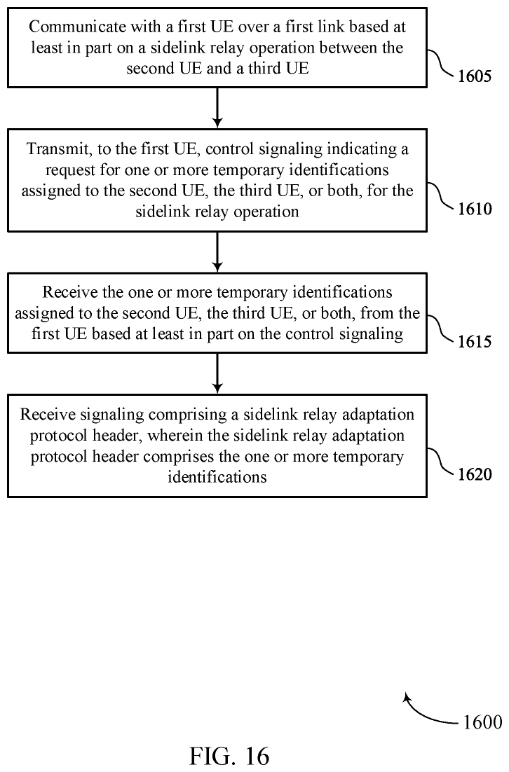

FIG. 16 shows a flowchart illustrating a method 1600 that supports path management of a sidelink relay between user equipment in accordance with one or more aspects of the present disclosure. The operations of the method 1600 may be implemented by a UE or its components as described herein. For example, the operations of the method 1600 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1605, the method may include communicating with a first UE over a first link based on a sidelink relay operation between the second UE and a third UE. The operations of 1605 may be performed in accordance with examples as disclosed herein. In some examples, aspects of the operations of 1605 may be performed by a relay operation component 1125 as described with reference to FIG. 11.

At 1610, the method may include transmitting, to the first UE, control signaling indicating a request for one or more temporary identifications assigned to the second UE, the third UE, or both, for the sidelink relay operation. The operations of 1610 may be performed in accordance with examples as disclosed herein. In some examples, aspects of the operations of 1610 may be performed by a temporary identification component 1130 as described with reference to FIG. 11.

At 1615, the method may include receiving the one or more temporary identifications assigned to the second UE, the third UE, or both, from the first UE based on the control signaling. The operations of 1615 may be performed in accordance with examples as disclosed herein. In some examples, aspects of the operations of 1615 may be performed by a temporary identification component 1130 as described with reference to FIG. 11.

At 1620, the method may include receiving signaling including a SRAP header, where the SRAP header includes the one or more temporary identifications. The operations of 1620 may be performed in accordance with examples as disclosed herein. In some examples, aspects of the operations of 1620 may be performed by an SRAP header component 1135 as described with reference to FIG. 11.

The following provides an overview of aspects of the present disclosure:

Aspect 1: A method for wireless communication at a first UE, comprising: relaying communications between one or more second UEs and a third UE based at least in part on a sidelink relay operation wherein the relaying comprises communicating with the one or more second UEs over a first link and communicating with the third UE over a second link; receiving, from the one or more second UEs, control signaling indicating a request for one or more temporary identifications assigned to the one or more second UEs, the third UE, or both, for the sidelink relay operation; and transmitting signaling comprising a SRAP header to the one or more second UEs and the third UE, wherein the SRAP header comprises the one or more temporary identifications.

Aspect 2: The method of aspect 1, further comprising: transmitting the one or more temporary identifications assigned to the one or more second UEs, the third UE, or both, to the one or more second UEs, the third UE, or both, based at least in part on the control signaling.

Aspect 3: The method of any of aspects 1 through 2, wherein transmitting the signaling comprises: relaying one or more messages associated with establishing an E2E link of a set of E2E links between the one or more second UEs and the third UE based at least in part on the sidelink relay operation, wherein the one or more messages comprise the SRAP header.

Aspect 4: The method of aspect 3, wherein the one or more messages comprise a link request, a security message, a dynamic channel assignment message, or any combination thereof.

Aspect 5: The method of any of aspects 1 through 4, wherein transmitting the signaling comprises: relaying one or more messages associated with an access stratum procedure, wherein the one or more messages comprise the SRAP header.

Aspect 6: The method of aspect 5, wherein relaying the one or more messages comprises: receiving a QoS message associated with the first link and the second link based at least in part on the access stratum procedure, wherein the one or more messages comprises the QOS message; relaying a sidelink radio link control channel message, wherein the sidelink radio link control channel message is determined based at least in part on the QoS message; relaying one or more updated temporary identifications assigned to the one or more second UEs, the third UE, or both, based at least in part on the QoS message; and determining a QoS split based at least in part on the QoS message.

Aspect 7: The method of any of aspects 5 through 6, wherein the one or more messages comprise a PC5 RRC message, one or more RRC reconfiguration sidelink messages, or any combination thereof.

Aspect 8: The method of any of aspects 1 through 7, further comprising: determining a first temporary identification assigned to the one or more second UEs, a second temporary identification assigned to the third UE, a temporary identification index pair associated with the one or more second UEs and the third UE, a radio bearer identification associated with the sidelink relay operation, or any combination thereof, based at least in part on the control signaling, wherein the SRAP header comprises the first temporary identification, the second temporary identification, the temporary identification index pair, the radio bearer identification, or any combination thereof.

Aspect 9: The method of any of aspects 1 through 8, further comprising: determining a RLF on the first link or the second link, wherein the first link and the second link are associated with a first E2E link of a set of E2E links; transmitting a failure message to the one or more second UEs or the third UE based at least in part on the determining the RLF; and communicating with the third UE based at least in part on a path management procedure, wherein the path management procedure comprises multiplexing reconfiguration or releasing the first link.

Aspect 10: The method of aspect 9, wherein transmitting the failure message comprises: transmitting the failure message to the one or more second UEs based at least in part on the RLF being associated with the second link; or transmitting the failure message to the third UE based at least in part on the RLF being associated with the first link.

Aspect 11: The method of any of aspects 1 through 10, further comprising: determining a sidelink measurement associated with the first link is below a threshold, wherein the threshold is configured, preconfigured, or both; and communicating with the third UE based at least in part on a path management procedure, wherein the path management procedure comprises multiplexing reconfiguration or releasing the first link.

Aspect 12: The method of any of aspects 1 through 11, wherein the control signaling comprises a PC5 RRC message and the first link and the second link comprise an E2E PC5 sidelink link.

Aspect 13: A method for wireless communication at a second UE, comprising: communicating with a first UE over a first link based at least in part on a sidelink relay operation between the second UE and a third UE; transmitting, to the first UE, control signaling indicating a request for one or more temporary identifications assigned to the second UE, the third UE, or both, for the sidelink relay operation; and receiving signaling comprising a SRAP header, wherein the SRAP header comprises the one or more temporary identifications.

Aspect 14: The method of aspect 13, further comprising: receiving the one or more temporary identifications assigned to the second UE, the third UE, or both, from the first UE based at least in part on the control signaling.

Aspect 15: The method of any of aspects 13 through 14, wherein receiving the signaling comprises: communicating one or more messages associated with establishing a set of E2E links between the second UE and the third UE based at least in part on the sidelink relay operation, wherein the one or more messages comprise one or more SRAP headers.

Aspect 16: The method of aspect 15, further comprising: determining that an E2E link of the set of E2E links associated with the first UE is active, wherein other E2E links of the set of E2E links are inactive.

Aspect 17: The method of any of aspects 15 through 16, wherein the one or more SRAP headers comprise a different SRAP header associated with each E2E link of the set of E2E links; and the one or more messages comprise a link request, a security message, a dynamic channel assignment message, or any combination thereof.

Aspect 18: The method of any of aspects 13 through 17, wherein receiving the signaling comprises: communicating one or more messages associated with an access stratum procedure, wherein the one or more messages comprise the SRAP header.

Aspect 19: The method of aspect 18, wherein communicating the one or more messages comprises: transmitting a QoS message associated with the first link and a second link, wherein the second link is associated with the sidelink relay operation, and wherein the one or more messages comprises the QoS message; receiving a sidelink radio link control channel message, wherein the sidelink radio link control channel message is determined based at least in part on the QoS message; and receiving one or more updated temporary identifications assigned to the second UE, the third UE, or both, based at least in part on the QoS message.

Aspect 20: The method of any of aspects 18 through 19, wherein the one or more messages comprise a PC5 RRC message, one or more RRC reconfiguration sidelink messages, or both.

Aspect 21: The method of any of aspects 13 through 20, further comprising: determining a first temporary identification assigned to the second UE, a second temporary identification assigned to the third UE, a temporary identification index pair associated with the second UE and the third UE, a radio bearer identification associated with the sidelink relay operation, or any combination thereof, based at least in part on the SRAP header.

Aspect 22: The method of any of aspects 13 through 21, further comprising: determining whether to release the first link based at least in part on a performance indication associated with the first link, a second link, or both, wherein the first link and the second link are associated with a first E2E link of a set of E2E links.

Aspect 23: The method of aspect 22, further comprising: receiving a failure message from the first UE based at least in part on a RLF associated with the second link, wherein the performance indication comprises the failure message; and communicating with the first UE based at least in part on a path management procedure, wherein the path management procedure comprises multiplexing reconfiguration or releasing the first link.

Aspect 24: The method of any of aspects 22 through 23, further comprising: determining a sidelink measurement associated with the first link is below a threshold, wherein the threshold is configured, preconfigured, or both, and the performance indication is indicative of the first link being below the threshold; and communicating with the first UE based at least in part on a path management procedure, wherein the path management procedure comprises multiplexing reconfiguration or releasing the first link.

Aspect 25: The method of any of aspects 22 through 24, further comprising: communicating with a fourth UE associated with a second E2E link of the set of E2E links based at least in part on a reselection procedure, wherein a start of the reselection procedure is based at least in part on the determining whether to release the first link.

Aspect 26: The method of aspect 25, wherein the reselection procedure comprises: deactivating the first E2E link; activating the second E2E link, wherein the second E2E link is determined based at least in part on sidelink measurements associated with a third link of the second E2E link, a fourth link of the second E2E link, or both; and communicating one or more messages associated with establishing the second E2E link based at least in part on the activating the second E2E link.

Aspect 27: The method of aspect 26, wherein the sidelink measurements comprise a minimum value of a sidelink reference signal received power (SL-RSRP), a sidelink discovery reference signal received power (SD-RSRP), or both, associated with the third link and the fourth link; a mean value of a SL-RSRP, a SD-RSRP, or both, associated with the third link and the fourth link; or a value of a SL-RSRP, a SD-RSRP, or both, associated with the third link.

Aspect 28: The method of any of aspects 13 through 27, wherein the control signaling comprises a PC5 RRC message and the first link and a second link associated with the sidelink relay operation comprise an E2E PC5 sidelink link.

Aspect 29: An apparatus for wireless communication at a first UE, comprising a processor; memory coupled with the processor; and instructions stored in the memory and executable by the processor to cause the apparatus to perform a method of any of aspects 1 through 12.

Aspect 30: An apparatus for wireless communication at a first UE, comprising at least one means for performing a method of any of aspects 1 through 12.

Aspect 31: A non-transitory computer-readable medium storing code for wireless communication at a first UE, the code comprising instructions executable by a processor to perform a method of any of aspects 1 through 12.

Aspect 32: An apparatus for wireless communication at a second UE, comprising a processor; memory coupled with the processor; and instructions stored in the memory and executable by the processor to cause the apparatus to perform a method of any of aspects 13 through 28.

Aspect 33: An apparatus for wireless communication at a second UE, comprising at least one means for performing a method of any of aspects 13 through 28.

Aspect 34: A non-transitory computer-readable medium storing code for wireless communication at a second UE, the code comprising instructions executable by a processor to perform a method of any of aspects 13 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a first user equipment (UE), comprising:
relaying communications between one or more second UEs and a third UE based at least in part on a sidelink relay operation wherein the relaying comprises communicating with the one or more second UEs over a first link and communicating with the third UE over a second link;
receiving, from the one or more second UEs, control signaling indicating a request for one or more temporary identifications assigned to the one or more second UEs, the third UE, or both, for the sidelink relay operation; and
transmitting signaling comprising a sidelink relay adaptation protocol header to the one or more second UEs and the third UE, wherein the sidelink relay adaptation protocol header comprises the one or more temporary identifications.

2. The method of claim 1, further comprising:
transmitting the one or more temporary identifications assigned to the one or more second UEs, the third UE, or both, to the one or more second UEs, the third UE, or both, based at least in part on the control signaling.

3. The method of claim 1, wherein transmitting the signaling comprises:
relaying one or more messages associated with establishing an end-to-end link of a set of end-to-end links between the one or more second UEs and the third UE based at least in part on the sidelink relay operation, wherein the one or more messages comprise the sidelink relay adaptation protocol header.

4. The method of claim 3, wherein the one or more messages comprise a link request, a security message, a dynamic channel assignment message, or any combination thereof.

5. The method of claim 1, wherein transmitting the signaling comprises:
relaying one or more messages associated with an access stratum procedure, wherein the one or more messages comprise the sidelink relay adaptation protocol header.

6. The method of claim 5, wherein relaying the one or more messages comprises:
receiving a quality of service message associated with the first link and the second link based at least in part on the access stratum procedure, wherein the one or more messages comprises the quality of service message;
relaying a sidelink radio link control channel message, wherein the sidelink radio link control channel message is determined based at least in part on the quality of service message;
relaying one or more updated temporary identifications assigned to the one or more second UEs, the third UE, or both, based at least in part on the quality of service message; and
determining a quality of service split based at least in part on the quality of service message.

7. The method of claim 5, wherein the one or more messages comprise a PC5 radio resource control (RRC) message, one or more RRC reconfiguration sidelink messages, or any combination thereof.

8. The method of claim 1, further comprising:
determining a first temporary identification assigned to the one or more second UEs, a second temporary identification assigned to the third UE, a temporary identification index pair associated with the one or more second UEs and the third UE, a radio bearer identification associated with the sidelink relay operation, or any combination thereof, based at least in part on the control signaling, wherein the sidelink relay adaptation protocol header comprises the first temporary identification, the second temporary identification, the temporary identification index pair, the radio bearer identification, or any combination thereof.

9. The method of claim 1, further comprising:
determining a radio link failure on the first link or the second link, wherein the first link and the second link are associated with a first end-to-end link of a set of end-to-end links;
transmitting a failure message to the one or more second UEs or the third UE based at least in part on the determining the radio link failure; and
communicating with the third UE based at least in part on a path management procedure, wherein the path management procedure comprises multiplexing reconfiguration or releasing the first link.

10. The method of claim 9, wherein transmitting the failure message comprises:
transmitting the failure message to the one or more second UEs based at least in part on the radio link failure being associated with the second link; or
transmitting the failure message to the third UE based at least in part on the radio link failure being associated with the first link.

11. The method of claim 1, further comprising:
determining a sidelink measurement associated with the first link is below a threshold, wherein the threshold is configured, preconfigured, or both; and
communicating with the third UE based at least in part on a path management procedure, wherein the path management procedure comprises multiplexing reconfiguration or releasing the first link.

12. The method of claim 1, wherein the control signaling comprises a PC5 radio resource control (RRC) message and the first link and the second link comprise an end-to-end PC5 sidelink link.

13. A method for wireless communication at a second user equipment (UE), comprising:
communicating with a first UE over a first link based at least in part on a sidelink relay operation between the second UE and a third UE;
transmitting, to the first UE, control signaling indicating a request for one or more temporary identifications assigned to the second UE, the third UE, or both, for the sidelink relay operation; and
receiving signaling comprising a sidelink relay adaptation protocol header, wherein the sidelink relay adaptation protocol header comprises the one or more temporary identifications.

14. The method of claim 13, further comprising:
receiving the one or more temporary identifications assigned to the second UE, the third UE, or both, from the first UE based at least in part on the control signaling.

15. The method of claim 13, wherein receiving the signaling comprises:
communicating one or more messages associated with establishing a set of end-to-end links between the second UE and the third UE based at least in part on the sidelink relay operation, wherein the one or more messages comprise one or more sidelink relay adaptation protocol headers.

16. The method of claim 15, further comprising:
determining that an end-to-end link of the set of end-to-end links associated with the first UE is active, wherein other end-to-end links of the set of end-to-end links are inactive.

17. The method of claim 15, wherein:
the one or more sidelink relay adaptation protocol headers comprise a different sidelink relay adaptation protocol header associated with each end-to-end link of the set of end-to-end links; and
the one or more messages comprise a link request, a security message, a dynamic channel assignment message, or any combination thereof.

18. The method of claim 13, wherein receiving the signaling comprises:
communicating one or more messages associated with an access stratum procedure, wherein the one or more messages comprise the sidelink relay adaptation protocol header.

19. The method of claim 18, wherein communicating the one or more messages comprises:
transmitting a quality of service message associated with the first link and a second link, wherein the second link is associated with the sidelink relay operation, and wherein the one or more messages comprises the quality of service message;
receiving a sidelink radio link control channel message, wherein the sidelink radio link control channel message is determined based at least in part on the quality of service message; and
receiving one or more updated temporary identifications assigned to the second UE, the third UE, or both, based at least in part on the quality of service message.

20. The method of claim 18, wherein the one or more messages comprise a PC5 radio resource control (RRC) message, one or more RRC reconfiguration sidelink messages, or both.

21. The method of claim 13, further comprising:
determining a first temporary identification assigned to the second UE, a second temporary identification assigned to the third UE, a temporary identification index pair associated with the second UE and the third UE, a radio bearer identification associated with the sidelink relay operation, or any combination thereof, based at least in part on the sidelink relay adaptation protocol header.

22. The method of claim 13, further comprising:
determining whether to release the first link based at least in part on a performance indication associated with the first link, a second link, or both, wherein the first link and the second link are associated with a first end-to-end link of a set of end-to-end links.

23. The method of claim 22, further comprising:
receiving a failure message from the first UE based at least in part on a radio link failure associated with the second link, wherein the performance indication comprises the failure message; and
communicating with the first UE based at least in part on a path management procedure, wherein the path management procedure comprises multiplexing reconfiguration or releasing the first link.

24. The method of claim 22, further comprising:
determining a sidelink measurement associated with the first link is below a threshold, wherein the threshold is configured, preconfigured, or both, and the performance indication is indicative of the first link being below the threshold; and
communicating with the first UE based at least in part on a path management procedure, wherein the path management procedure comprises multiplexing reconfiguration or releasing the first link.

25. The method of claim 22, further comprising:
communicating with a fourth UE associated with a second end-to-end link of the set of end-to-end links based at least in part on a reselection procedure, wherein a start of the reselection procedure is based at least in part on the determining whether to release the first link.

26. The method of claim 25, wherein the reselection procedure comprises:
deactivating the first end-to-end link;
activating the second end-to-end link, wherein the second end-to-end link is determined based at least in part on sidelink measurements associated with a third link of the second end-to-end link, a fourth link of the second end-to-end link, or both; and
communicating one or more messages associated with establishing the second end-to-end link based at least in part on the activating the second end-to-end link.

27. The method of claim 26, wherein the sidelink measurements comprise:
a minimum value of a sidelink reference signal received power (SL-RSRP), a sidelink discovery reference signal received power (SD-RSRP), or both, associated with the third link and the fourth link;
a mean value of a SL-RSRP, a SD-RSRP, or both, associated with the third link and the fourth link; or
a value of a SL-RSRP, a SD-RSRP, or both, associated with the third link.

28. The method of claim 13, wherein the control signaling comprises a PC5 radio resource control (RRC) message and the first link and a second link associated with the sidelink relay operation comprise an end-to-end PC5 sidelink link.

29. An apparatus for wireless communication at a first user equipment (UE), comprising:
a processor;
memory coupled with the processor; and
instructions stored in the memory and executable by the processor to cause the apparatus to:
relay communications between one or more second UEs and a third UE based at least in part on a sidelink relay operation wherein the relaying comprises communicating with the one or more second UEs over a first link and communicating with the third UE over a second link;
receive, from the one or more second UEs, control signaling indicating a request for one or more temporary identifications assigned to the one or more second UEs, the third UE, or both, for the sidelink relay operation; and
transmit signaling comprising a sidelink relay adaptation protocol header to the one or more second UEs and the third UE, wherein the sidelink relay adaptation protocol header comprises the one or more temporary identifications.

30. An apparatus for wireless communication at a second user equipment (UE), comprising:
a processor;
memory coupled with the processor; and
instructions stored in the memory and executable by the processor to cause the apparatus to:
communicate with a first UE over a first link based at least in part on a sidelink relay operation between the second UE and a third UE;
transmit, to the first UE, control signaling indicating a request for one or more temporary identifications assigned to the second UE, the third UE, or both, for the sidelink relay operation; and
receive signaling comprising a sidelink relay adaptation protocol header, wherein the sidelink relay adaptation protocol header comprises the one or more temporary identifications.
